(19) United States
(12) Patent Application Publication
(10) Pub. No.: US 2026/0084848 A1
(43) Pub. Date: Mar. 26, 2026

(54) APPARATUSES AND METHOD FOR PREPARING A PAPER BAG

(71) Applicant: Dowson Food Machinery Limited, Ilkley, West Yorkshire (GB)

(72) Inventors: Joseph HOLLIDAY, Ilkley, West Yorkshire (GB); Numburi HARSHA, lIkley (GB); Sean O'HARA, lIkley (GB); Stephen CLARKE, lIkley (GB); William ALCOCK, lIkley (GB); Nickolas DIBB, lIkley (GB)

(21) Appl. No.: 19/111,078

(22) PCT Filed: Sep. 13, 2023
(86) PCT No.: PCT/GB2023/052371

§ 371 Date: Mar. 12, 2025

(30) Foreign Application Priority Data
Sep. 13, 2022 (GB) 2213367.2

(51) Int. Cl. B65B 7/08; B65B 7/10; B65B 25/16

(52) U.S. Cl. CPC B65B 7/08; B65B 7/10; B65B 25/16

(57) ABSTRACT

There is disclosed a bag folding assembly for a packaging apparatus for preparing a paper bag to be closed, the bag folding assembly comprising: a first jaw assembly and a second jaw assembly centred on a common operational axis, wherein: each jaw assembly is configured to transition between an open configuration and a closed configuration; the first jaw assembly and second jaw assembly are arranged with the jaws facing one another such that they are operable to grasp the region of the paper bag towards opposite edges of the region of the paper bag; the first jaw assembly and second jaw assembly are configured to simultaneously rotate about the operational axis to fold the paper bag by turning the region of the paper bag with respect to the operational axis. There is also disclosed a method for closing a paper bag, and a packaging apparatus.

The present disclosure relates to a bag folding assembly, a packaging apparatus and a method for closing a paper bag.

### BACKGROUND

Automated techniques are known for closing plastic bags, for example, which contain food items. Such known techniques may be used for closing plastic bags. For example, the mouth region of a plastic bag filled with a food item (e.g., bread) may be crimped, twisted, etc., and be held closed with a sticker and the like. There may be dedicated packaging machinery used to close plastic bags in this manner.

It is becoming desirable to use packaging which does not employ plastic. As such, paper bags for packaging food items are becoming more desirable. However, conventional automated techniques for closing and sealing bags may not be appropriate for paper bags. For example, crimping or twisting to close the mouth region of a paper bag may leave a gap at the centre of the closed mouth region such that the food item inside is more exposed to air compared to the same technique used with a plastic bag.

Paper bags containing food items such as bread may be closed by hand, for example, by creating a series of folds in the mouth region of the paper bag to better close the paper bag. However, closing paper bags by hand is labour intensive and time consuming. There may also be variability in the quality and tidiness of paper bags closed by hand. Therefore, apparatuses and methods for automatically closing a paper bag are highly desired.

### SUMMARY

According to a first aspect of the present disclosure, there is provided a bag folding assembly for a packaging apparatus for preparing a paper bag to be closed, the bag folding assembly comprising: a first jaw assembly and a second jaw assembly centred on a common operational axis, wherein: each jaw assembly is configured to transition between an open configuration and a closed configuration wherein: in the open configuration the respective jaws are spread to be spaced apart from a region of a paper bag, and in the closed configuration the respective jaws are configured to grasp the region of the paper bag such that sliding of the region of the paper bag relative to the respective jaw assembly is inhibited; the first jaw assembly and second jaw assembly are arranged with the jaws facing one another such that they are operable to grasp the region of the paper bag towards opposite edges of the region of the paper bag; the first jaw assembly and second jaw assembly are configured to perform a rotation operation by simultaneously rotating about the operational axis to fold the paper bag by turning the region of the paper bag with respect to the operational axis; each jaw of the first and second jaw assembly comprises a first lateral end and a second lateral end, the first lateral end and the second lateral end being separated by a width of said jaw, wherein the width of said jaw is perpendicular to the thickness of the jaw and perpendicular to the operational axis; the operational axis is positioned closer to one of the first and second lateral ends, as compared to the other of the first and second lateral ends; and in use, a separation between a longitudinal axis of the paper bag and the operational axis along a first direction remains substantially constant during the rotation operation, wherein the first direction is perpendicular to the longitudinal axis of the paper bag and perpendicular to the operational axis.

Optionally, each jaw assembly is configured to grasp the region of the paper bag such that sliding of the region of the paper bag relative to the respective jaw assembly is prevented during the rotation operation.

Optionally, the jaw assemblies are configured to move away from one another during the rotation operation.

Optionally, the jaw assemblies are configured to move away from one another in a continuous manner during the rotation operation; or the jaw assemblies are configured to move away from one another in a step-wise manner during the rotation operation.

Optionally, each of the jaw assemblies comprises a gripping arrangement configured to generate friction between the jaws of the respective jaw assembly and the region of the paper bag when the region of the paper bag is grasped by the respective jaw assembly.

Optionally, the gripping arrangement comprises a high friction member provided on each jaw, the high friction member configured to contact the region of the paper bag when the respective jaw assembly grasps the region of the paper bag.

Optionally, each of the first and second jaw assemblies is configured to: adopt a fold release configuration in which the respective jaws are marginally more open as compared to the closed configuration such that, when the region of the paper bag is positioned between the respective jaws, the region of the paper bag is able to readily slide relative to the respective jaw assembly.

Optionally, the first and second jaw assemblies are configured to adopt the fold release configuration after performing the rotation operation, and move apart from one another after adopting the fold release configuration.

Optionally, the operational axis is positioned closer to the first lateral end of each jaw; and a first space created between the first lateral end of each jaw and the region of the paper bag during the rotation operation is greater than a second space created between the second lateral end of each jaw and the region of the paper bag during the rotation operation.

Optionally, the first and second jaw assemblies are configured to move apart from one another after performing the rotation operation, while still in the closed configuration.

Optionally, the first and second jaw assemblies are configured to move with respect to a level change axis simultaneously, wherein the level change axis is perpendicular to the operational axes.

Optionally, the first and second jaw assemblies are configured to move with respect to the level change axis during the rotation operation.

Optionally, the first and second jaw assemblies are configured to simultaneously perform the rotation operation when each jaw assembly is in the closed configuration.

Optionally, each jaw is detachably connected to its respective jaw assembly.

Optionally, each jaw assembly comprises a jaw detachable connection mechanism configured to allow a user to manually detach and re-attach jaws onto the respective jaw assembly.

Optionally, the rotation operation comprises any rotation comprising an integer number of turns, a fractional number of turns or a combination of an integer number of turns and a fractional number of turns.

Optionally, the first and second jaw assemblies are configured such that the rotation of the rotation operation is controlled to a precision of one degree.

According to a second aspect of the present invention, there is provided a bag folding system for a packaging apparatus for preparing a paper bag to be closed, the bag folding system comprising: the bag folding assembly according to the first aspect in which each jaw is detachably connected to its respective jaw assembly; and a plurality of sets of jaws, wherein each set of jaws comprises jaws having a width different to the widths of the jaws of the other sets of jaws in the plurality of sets of jaws.

According to a third aspect of the present invention, there is provided a packaging apparatus for preparing a paper bag to be closed, the packaging apparatus comprising: the bag folding assembly according to the first aspect, wherein the region of the paper bag is a mouth region; and a mouth preparation finger assembly comprising a plurality of fingers in the form of elongate members for performing a mouth preparation operation to prepare the mouth region of the paper bag such that it is formed into a flat mouth portion of the paper bag; wherein, the bag folding assembly is configured to grasp the flat mouth portion resulting from the mouth preparation operation performed by the mouth preparation finger assembly.

Optionally, in the packaging apparatus according to the third aspect, the mouth preparation finger assembly comprises: a first pair of inner fingers, wherein the inner fingers of the first pair are spaced apart from one another with respect to a first axis; a second pair of inner fingers, wherein the inner fingers of the second pair are spaced apart from one another with respect to the first axis, and the first pair of inner fingers is spaced apart from the second pair of inner fingers with respect to a second axis which is perpendicular to the first axis; and a pair of outer fingers, wherein the outer fingers are spaced apart from one another with respect to the first axis, and the position of the outer fingers with respect to the second axis is between the position of the first pair of inner fingers and the second pair of inner fingers with respect to the second axis, wherein, the mouth preparation operation comprises: moving from an insertion configuration to a mouth opening configuration to open up the mouth of the paper bag; and moving from the mouth opening configuration to a mouth flattening configuration to create the flat mouth portion of the paper bag.

Optionally, in the packaging apparatus according to the third aspect, the mouth preparation finger assembly is configured to grasp the flat mouth portion, when in the mouth flattening configuration, such that movement of the flat mouth portion relative to the mouth preparation finger assembly along a third axis is inhibited, the third axis being perpendicular to the second axis and perpendicular to the first axis.

Optionally, in the packaging apparatus according to the third aspect, one or more of the first pair of inner fingers, second pair of inner fingers and the pair of outer fingers comprises a friction coating for creating friction between the respective fingers and the paper bag.

Optionally, in the packaging apparatus according to the third aspect, the mouth preparation finger assembly is configured to move, when in the mouth flattening configuration, along the third axis to pull the paper bag away from a conveyor and into a jaw grasping position.

Optionally, the packaging apparatus according to the second aspect comprises: a pusher mechanism configured to push the paper bag towards the mouth preparation finger assembly for the mouth region to engage with the mouth preparation finger assembly.

Optionally, in the packaging apparatus according to the second aspect: the pusher mechanism is configured to push the paper bag from a top conveyor onto a packaging platform proximal to the mouth preparation finger assembly as compared to the top conveyor; and the packaging platform is oriented such that the mouth region of the paper bag is positioned above an end of the paper bag opposite to the mouth region.

Optionally, in the packaging apparatus according to the second aspect: the packaging platform forms an angle of 10 degrees relative to the ground.

Optionally, in the packaging apparatus according to the second aspect: the packaging platform comprises a driven belt for conveying the paper bag towards the mouth preparation finger assembly; and the pusher mechanism is configured to accelerate to match an operation speed of the driven belt of the packaging platform.

Optionally, in the packaging apparatus according to the second aspect: the mouth preparation finger assembly comprises an air blower configured to blow air towards the mouth region immediately before the mouth region reaches the mouth preparation finger assembly.

Optionally, in the packaging apparatus according to the second aspect: the length of the fingers is such that at least some of the fingers are in contact with the contents inside the paper bag, when the paper bag is in a jaw grasping position.

Optionally. in the packaging apparatus according to the second aspect: the driven belt is configured to decelerate starting from a time immediately before the at least some of the elongate members are in contact with the contents inside the paper bag.

Optionally, in the packaging apparatus according to the third aspect, the mouth preparation finger assembly is configured to move from the mouth flattening configuration to a finger extraction configuration.

Optionally, in the packaging apparatus according to the third aspect, the first and second jaw assemblies are configured to grasp the flat mouth portion when the flat mouth portion is engaged with the mouth preparation finger assembly, and before, during or after movement from the mouth flattening configuration to the finger extraction configuration.

Optionally, in the packaging apparatus according to the third aspect, in the insertion configuration, the position of the first pair of inner fingers and the second pair of inner fingers with respect to the first axis is between the position of the outer fingers with respect to the first axis; and the mouth preparation finger assembly is configured such that each of the inner fingers moves away from the other inner fingers in a plane defined by the second axis and the first axis to move from the insertion configuration to the mouth opening configuration, wherein, optionally: the mouth preparation finger assembly is configured such that during the movement from the insertion configuration to the mouth opening configuration, each of the inner fingers move with respect to the second axis and the first axis simultaneously.

Optionally, in the packaging apparatus according to the third aspect, the mouth preparation finger assembly is configured such that the first pair of inner fingers moves closer to the second pair of inner fingers with respect to the second axis and the outer fingers move closer to one another, in order to move from the mouth opening configuration to the mouth flattening configuration.

Optionally, in the packaging apparatus according to the third aspect, in order to create the flat mouth portion of the paper bag, the mouth preparation finger assembly is configured to: manipulate the mouth region so as to create an inward fold in a first side of the paper bag and bring together the corners of the first side of the paper bag at the mouth region; and manipulate the mouth region so as to create an inward fold in a second side of the paper bag and bring together the corners of the second side of the paper bag at the mouth region.

According to a fourth aspect of the present invention, there is provided a method for closing a paper bag, the method comprising: preparing, using a mouth preparation finger assembly, a mouth region of the paper bag such that it is formed into a flat mouth portion of the paper bag; transitioning the flat mouth portion from engagement with the mouth preparation finger assembly to engagement with a bag folding assembly; and folding, using the bag folding assembly, the flat mouth portion in the direction of the centre of the paper bag using a rotation operation.

Optionally, in the method according to the fourth aspect, the mouth portion is formed into the flat mouth portion by the mouth preparation finger assembly when the paper bag is positioned on a top conveyor, the method comprising: pulling, using the mouth preparation finger assembly, the paper bag off of the top conveyor and into a bag folding assembly grasping position; grasping, using the bag folding assembly, the flat mouth portion while the paper bag is in the bag folding assembly grasping position and before the mouth preparation finger assembly disengages from the flat mouth portion.

Optionally, the method according to the fourth aspect comprises: pushing the paper bag, using a pusher mechanism, from a top conveyor onto an upwardly angled packaging platform; and forming the mouth portion into the flat mouth portion using the mouth preparation finger assembly.

Optionally, the method according to the fourth aspect comprises: moving the paper bag in a lowering direction into a paper bag sealing position; performing, using a paper bag sealing assembly, a paper bag sealing operation to secure the folded mouth portion of the paper bag and provide the paper bag as a closed paper bag; and depositing the closed paper bag onto a bottom conveyor positioned lower than the top conveyor with respect to a second axis.

Optionally, in the method according to the fourth aspect, the paper bag sealing assembly performs the paper bag sealing operation before the bag folding assembly disengages from the folded mouth portion.

According to a fifth aspect of the present disclosure, there is provided a bag folding assembly for a packaging apparatus for preparing a paper bag to be closed, the bag folding assembly comprising: a first jaw assembly and a second jaw assembly centred on a common operational axis, wherein: each jaw assembly is configured to transition between an open configuration and a closed configuration wherein: in the open configuration the respective jaws are spread to be spaced apart from a region of a paper bag, and in the closed configuration the respective jaws are configured to grasp the region of the paper bag such that sliding of the region of the paper bag relative to the respective jaw assembly is inhibited; the first jaw assembly and second jaw assembly are arranged with the jaws facing one another such that they are operable to grasp the region of the paper bag towards opposite edges of the region of the paper bag; the first jaw assembly and second jaw assembly are configured to simultaneously rotate about the operational axis to fold the paper bag by turning the region of the paper bag with respect to the operational axis.

### BRIEF DESCRIPTION OF THE DRAWINGS

Examples of the present disclosure will now be described with reference to the accompanying drawings, in which:

FIG. 1 is a schematic perspective partial view of a bag folding assembly, according to examples;

FIG. 2 is a schematic front on partial view of the bag folding assembly, according to examples;

FIGS. 3a to 3f are schematic perspective full and partial views of the bag folding assembly and a paper bag at different stages of interaction, according to examples;

FIGS. 4a to 4f are schematic front on full and partial views of the bag folding assembly and the paper bag at different stages of interaction, according to examples;

FIG. 5 is a schematic side view of a first jaw assembly, according to examples; FIGS. 6a to 6c are schematic perspective views of a packaging apparatus and the paper bag at different stages of interaction, according to examples;

FIG. 7a is a schematic perspective view of a mouth preparation finger assembly, according to examples;

FIG. 7b is a schematic front on view of the mouth preparation finger assembly, according to examples;

FIG. 7c is a schematic plan view of the mouth preparation finger assembly, according to examples;

FIG. 7d is a schematic side view of the mouth preparation finger assembly, according to examples;

FIG. 7e is a schematic side cross-sectional view of the mouth preparation finger assembly, according to examples;

FIGS. 8a to 8c are schematic front on views of the mouth preparation finger assembly and a mouth region of a paper bag at different stages of interaction, according to examples;

FIGS. 9a to 9c are schematic perspective views of the mouth preparation finger assembly and the mouth region of the paper bag at different stages of interaction, according to examples;

FIG. 10 is a flow diagram illustrating a method for closing a paper bag, according to examples.

FIG. 11 a schematic plan view of example jaws, according to examples;

FIG. 12 is a sketch indicating a first positional relationship involving an operational axis and a paper bag;

FIG. 13 is a sketch indicating a second positional relationship involving the operational axis and the paper bag;

FIG. 14 is a schematic side view as viewed along the operational axis, according to examples;

FIG. 15 is a schematic front cross-sectional view as viewed along a paper bag longitudinal axis, according to examples; and

FIG. 16 a schematic side view of examples comprising a pusher mechanism, according to examples.

### DETAILED DESCRIPTION

The present disclosure relates to a bag folding assembly for a packaging apparatus, the packaging apparatus, and a method for closing a paper bag. The features of this disclosure provide for automated closing of paper bags in an assembly line, for example containing food items. The disclosed features may provide for paper bags to be closed in a manner that is time efficient, results in neat and reliable bag closure, and/or reduces exposure to air of the items inside, for example.

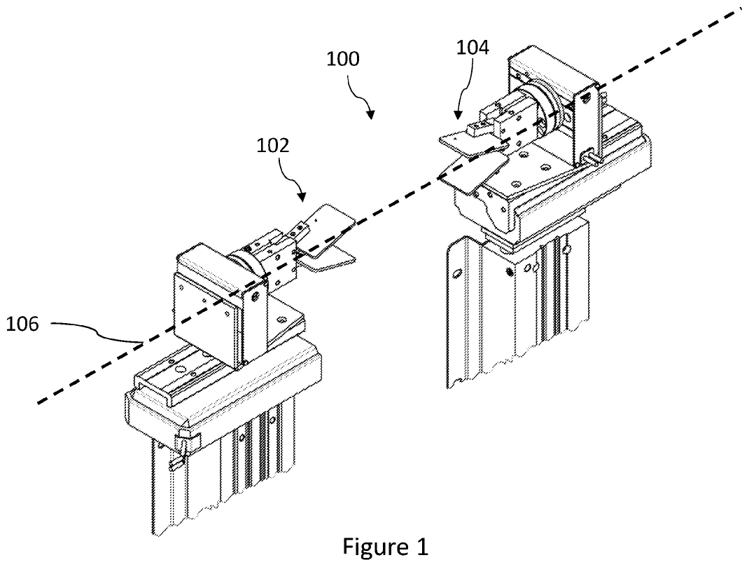

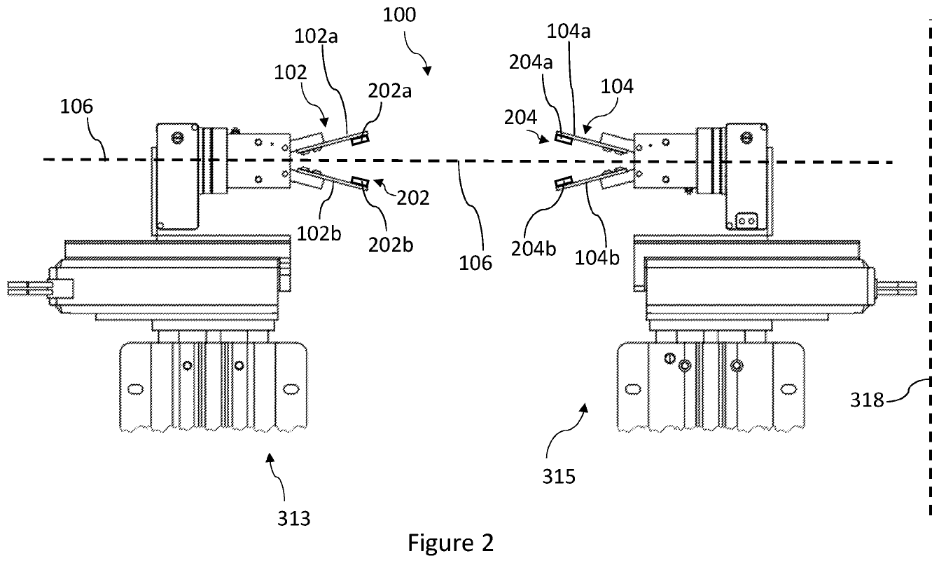

FIG. 1 is a schematic perspective view of a bag folding assembly 100 for a packaging apparatus for preparing a paper bag to be closed, according to examples. In these examples, the bag folding assembly 100 comprises a first jaw assembly 102 and a second jaw assembly 104 centred on a common operational axis 106. FIG. 2 is a schematic side view of the bag folding assembly 100, according to examples. In the orientation of FIG. 2, the operational axis 106 lies in the plane of the page. The operational axis 106 is a common operational axis in the sense that the first jaw assembly 102 and the second jaw assembly 104 both operate, in the manner discussed in more detail below, with respect to the same operational axis 106. In these examples, the operational axis 106 is defined relative to the position and orientation of the first and second jaw assemblies 102, 104.

In the examples described herein, each jaw assembly comprises a pair of jaws. In these examples, the first jaw assembly 102 comprises a first jaw 102a and a second jaw 102b. In these examples, the second jaw assembly 104 comprises a third jaw 104a and a fourth jaw 104b.

In these examples, each jaw assembly 102, 104 is configured to transition between an open configuration and a closed configuration. In the open configuration, the respective jaws are spread apart to be spaced apart from a region of a paper bag. For example, in use, the jaws are spread apart from the region of the paper bag positioned therebetween when in the open configuration. In the examples of FIG. 1, the first jaw assembly 102 is in the open configuration with its respective jaws 102a, 102b spread apart, and the second jaw assembly 104 is also in the open configuration with its respective jaws 104a, 104b spread apart. The interaction of the jaw assemblies 102, 104 with a paper bag is described in further detail below.

In these examples, in the closed configuration, the respective jaws are configured to grasp the region of the paper bag such that sliding of the region of the paper bag relative to the respective jaw assembly is inhibited. The way in which sliding is inhibited is described in further detail below. However, in some examples as further described below, the respective jaws are configured to grasp the region of the paper bag such that sliding of the region of the paper bag relative to the respective jaw assembly is inhibited to an extent, but not prevented. For example, such sliding may not be prevented or significantly hindered upon linear movements (as described below) of the jaw assemblies 102, 104.

In these examples, the first jaw assembly 102 and the second jaw assembly 104 are arranged with the jaws facing one another such that they are operable to grasp the region of the paper bag towards opposite edges of the region of the paper bag. In these examples, the first jaw assembly 102 and the second jaw assembly 104 are configured to perform a rotation operation by simultaneously rotating about the operational axis 106 to fold the paper bag by turning the region of the paper bag with respect to the operational axis 106.

In these examples, each jaw assembly 102, 104 comprises a pair of jaws. In the particular examples shown in the Figures, each jaw is a flat rectangular plate. The first jaw assembly 102 comprises the first jaw 102a and the second jaw 102b, for example, each in the form of a rectangular plate. The second jaw assembly 104 comprises the third jaw 104a and the fourth jaw 104b, for example, each in the form of a rectangular plate. In these examples, the flat rectangular plate is connected to the remainder of the respective jaw assembly via a jaw mounting arm functionally connected to a movement providing mechanism (e.g., a motor and the like) which operates to move the respective jaw between the open configuration and the closed configuration, as discussed below. The examples shown in the Figures are specific examples of the jaw assemblies. In other example, the jaw assemblies may comprise jaws of a different construction. It will be appreciated that the function of the jaws is to grasp the region of the paper bag and manipulate it in the manner described herein. Those skilled in the art will appreciate that such function may be achieved by using various different constructions of the jaw assemblies.

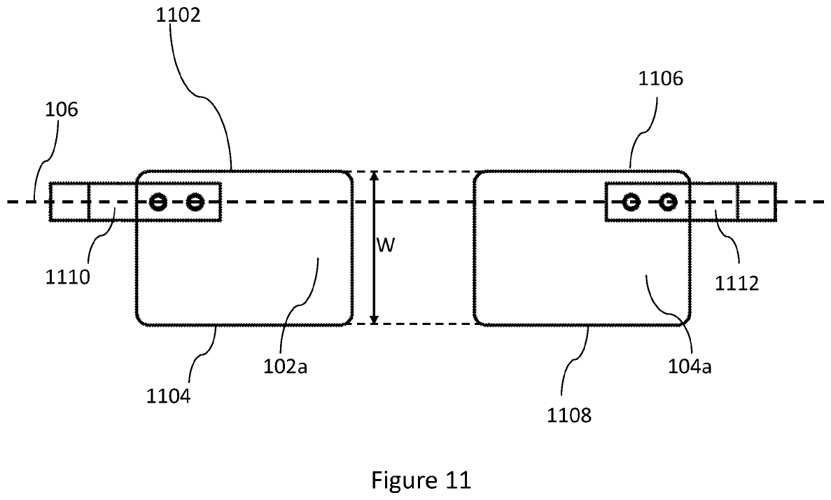

In these examples, each jaw 102a, 102b, 104a, 104b, of the first and second jaw assemblies 102, 104 comprises a first lateral end and a second lateral end separated by a width of said jaw. FIG. 11 is a schematic plan view of the first jaw 102a and the third jaw 104a, according to examples. In FIG. 11, only the first and third jaws 102a, and 104a are shown. However, the description in relation to FIG. 11 would also apply, mutatis mutandis, to the second and fourth jaws 102b, 104b. As referred to herein, the width of each jaw is perpendicular to the thickness of said jaw, and perpendicular to the operational axis 106. In the examples of FIG. 11, the operational axis 106 is indicated. It will be understood that in these examples, the thickness of the first and third jaws 102a, 104a would be in a direction into the page.

In these examples, the first jaw 102a has a first lateral end 1102 and a second lateral end 1104. The first and second lateral ends 1102, 1104 of the first jaw 102a are separated by the width W, indicated in FIG. 11 using a double-sided arrow. In these examples, the third jaw 104a has a first lateral end 1106 and a second lateral end 1108. The first and second lateral ends 1106, 1108 of the third jaw 104a are also separated by the width W. It will be appreciated that to create uniform folds of the paper bag, examples may have jaws which are the same in terms of shape, dimension and the like.

In these examples, there is also shown a first jaw mounting arm 1110 which connects the first jaw 102a to the remainder of the first jaw assembly 102, and there is shown a third jaw mounting arm 1112 which connects the third jaw 104a to the remainder of the second jaw assembly 104. It should be noted that in examples, the second 102b, and fourth 104b jaws would also have a respective second and fourth jaw mounting arms which connect those jaws to their respective jaw assemblies.

For example, the operational axis 106 is positioned closer to one of the first 1102, 1106 and second 1104, 1108 lateral ends, as compared to the other of the first 1102, 1106 and second 1104, 1108 lateral ends. In the specific examples of FIG. 11, the operational axis 106 is closer to the first lateral ends 1102, 1106. It should be noted that a particular offset of the operational axis 106 (towards the first lateral ends 1102, 1106) is shown in these examples. However, the amount of offset may vary depending on the desired nature of the rotation operation.

The positioning of the operational axis 106 closer towards one lateral edge means that the jaws 102, 102b, 104a, 104b do not rotate about their own centre with respect to their widths. Instead, in the specific examples of FIG. 11, while rotating about the operational axis 106, the second lateral ends 1104, 1108 would describe a larger rotation radius than the first lateral ends 1102, 1106.

For example, in use, a separation between a longitudinal axis of the paper bag 300 and the operational axis 106 along a first direction remains substantially constant during the rotation operation. The first direction is perpendicular to the longitudinal axis of the paper bag 300 and perpendicular to the operational axis 106.

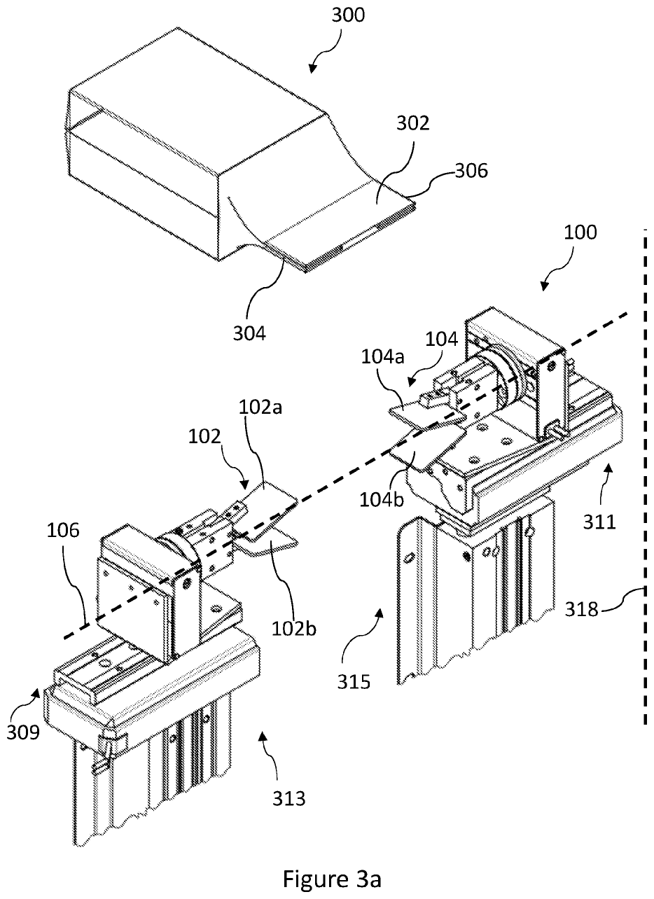

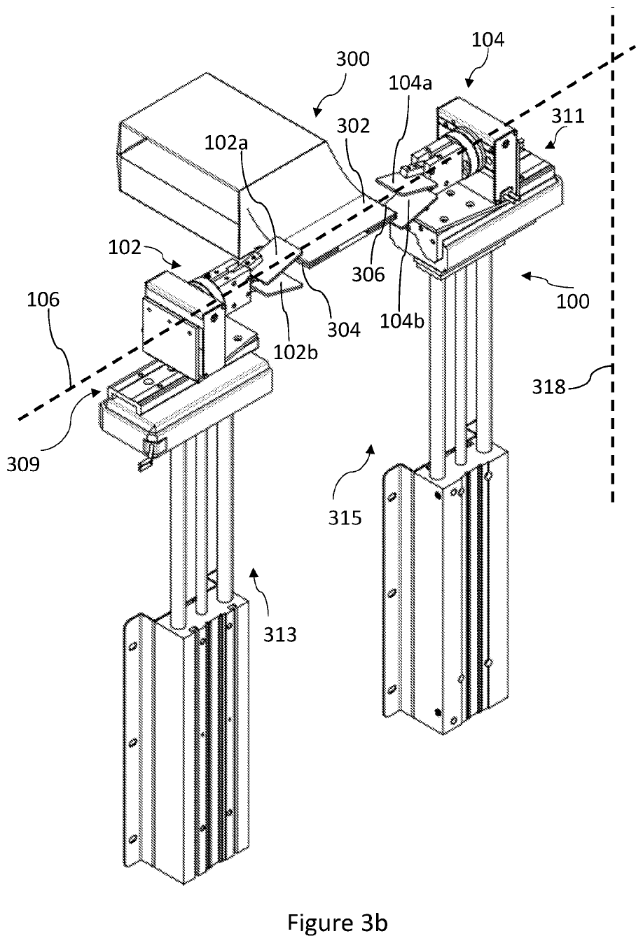

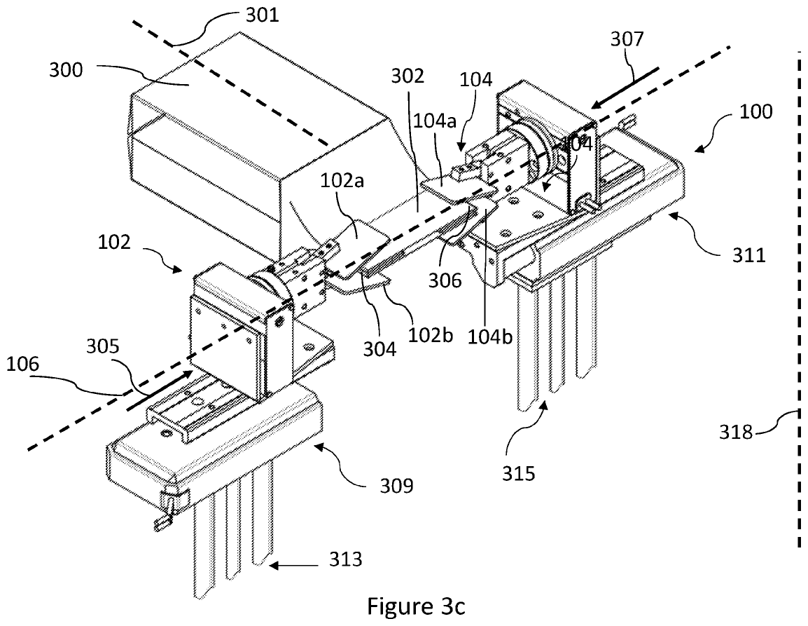

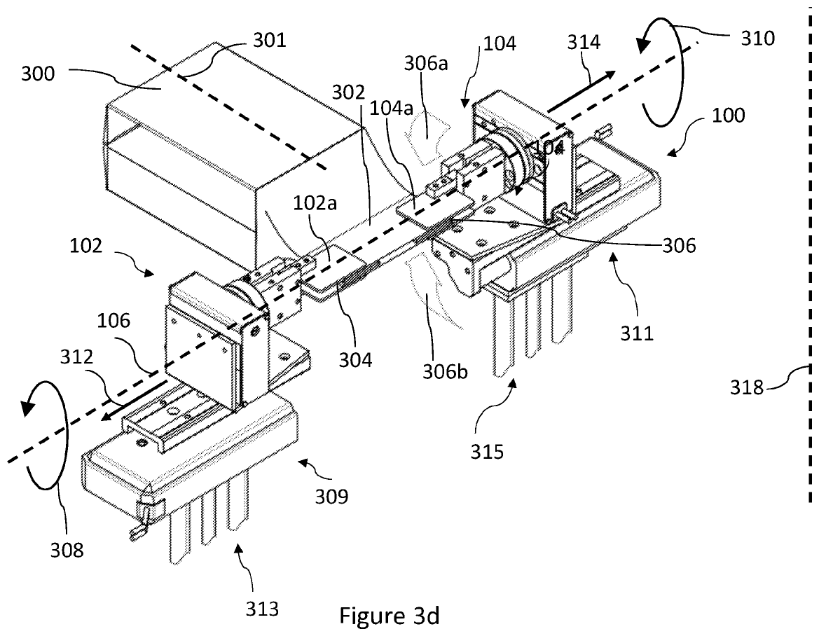

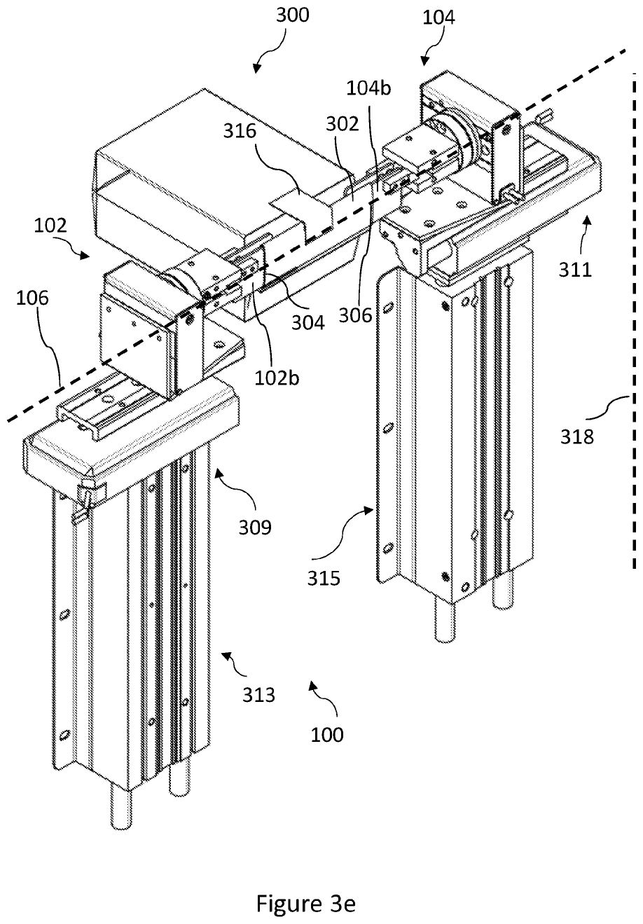

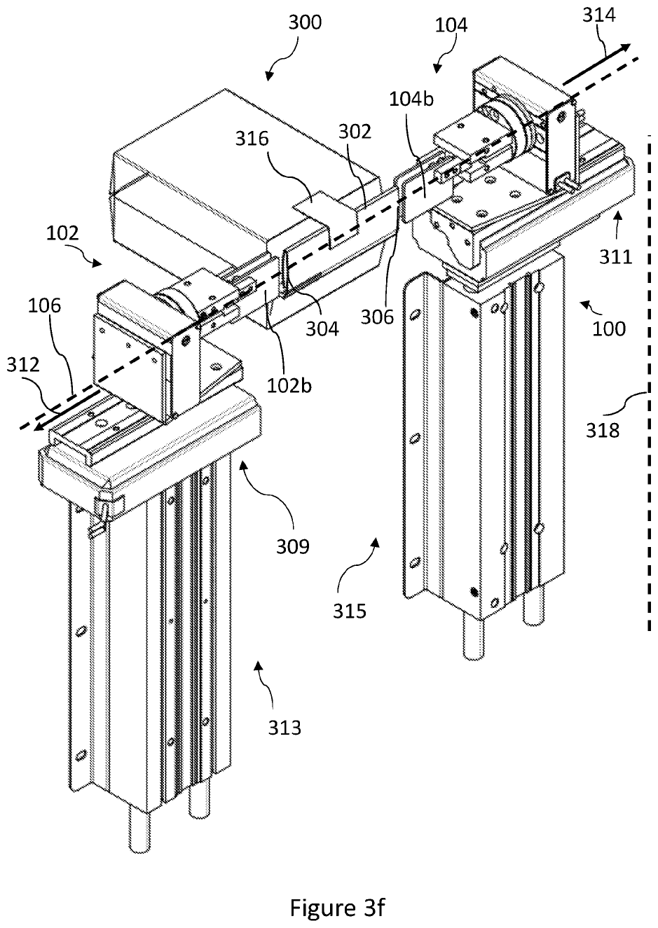

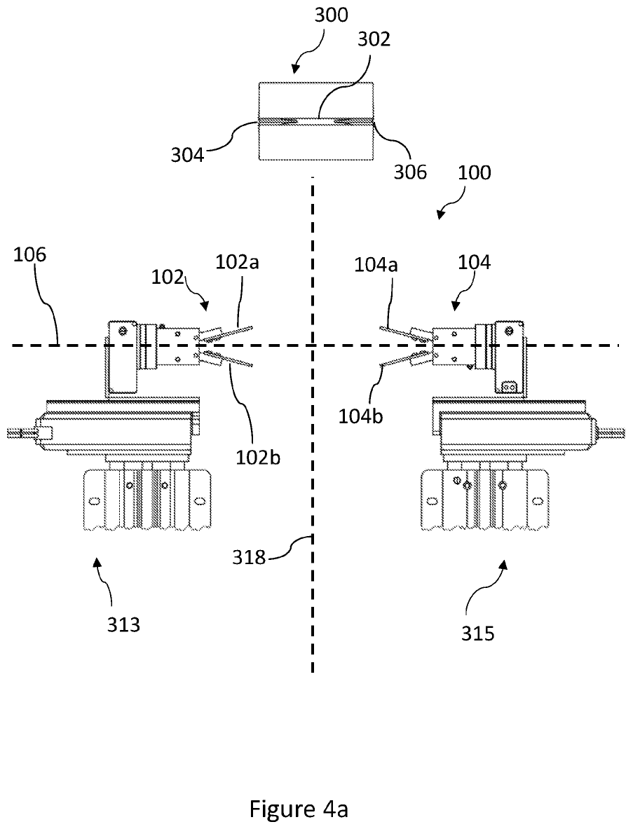

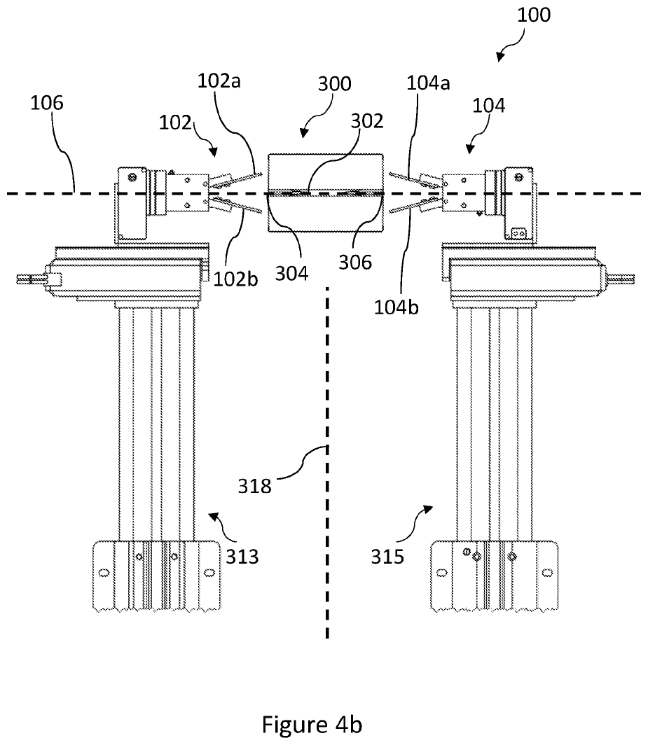

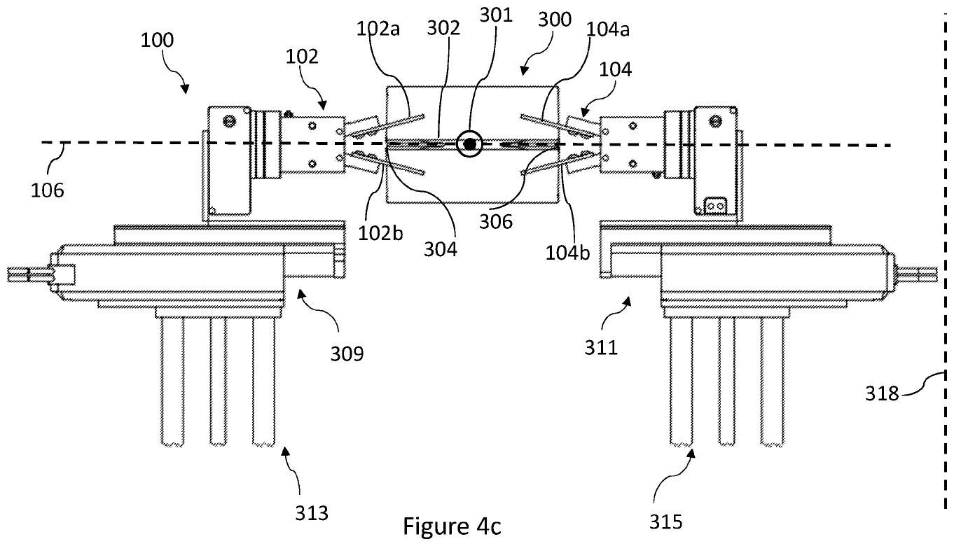

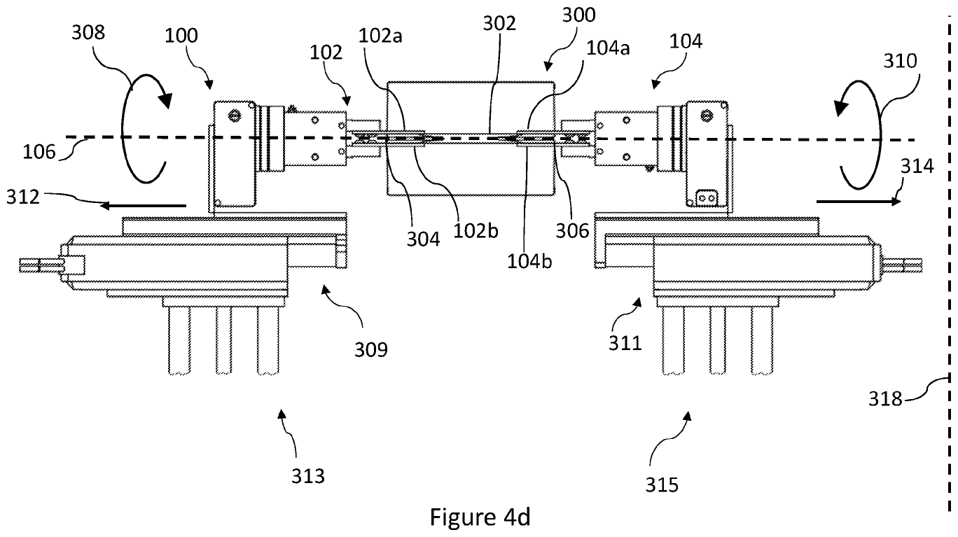

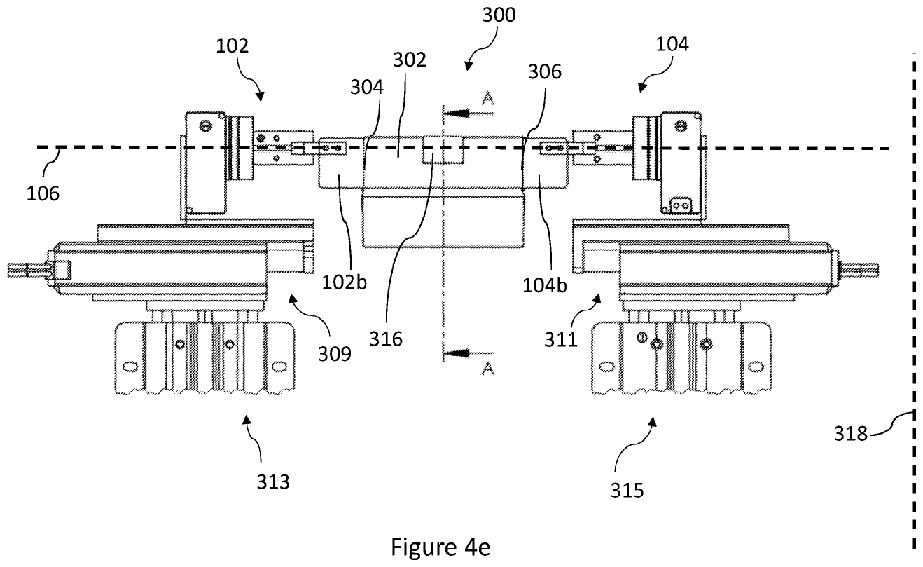

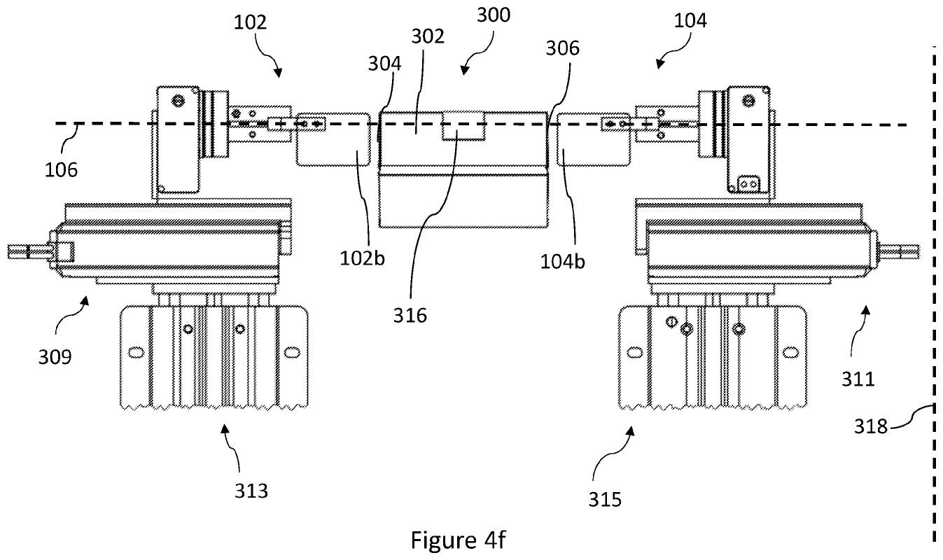

Referring to FIGS. 3c, 3d, and 4c, the longitudinal axis 301 of the paper bag 300 is indicated. The longitudinal axis 301 is hereafter referred to as the paper bag longitudinal axis 301. The paper bag longitudinal axis 301 is perpendicular to the operational axis 106. It will be appreciated that the desired folds are to be caused by a rotation perpendicular to the paper bag longitudinal axis 301.

In these examples, there is shown a level change axis 318. For example, the level change axis 318 indicates a direction in which the first and second jaw assemblies 102, 104 and the paper bag 300 may together move in a downwardly direction in the orientation shown in the Figures, as described further below. For example, such a level change may be implemented to proceed to a next stage of the packaging process. In the examples of FIGS. 3e, 3f and 4c, the first direction is parallel to the level change axis 318.

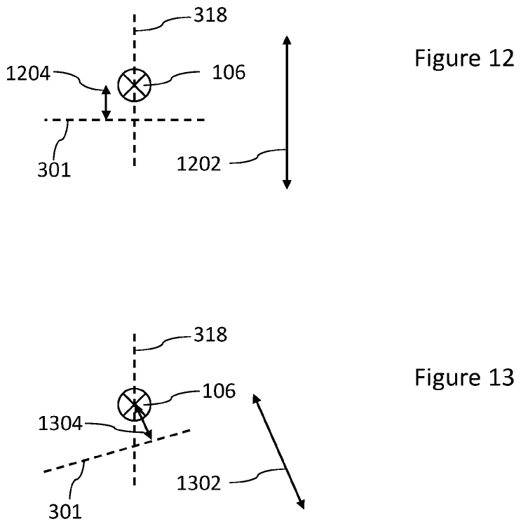

In these examples, the separation between the paper bag longitudinal axis 301 and the operational axis 106 does not change with respect to the level change axis 318. FIG. 12 is a view from a direction along the operational axis 106. FIG. 12 depicts the positional relationship between the operational axis 106 and the paper bag longitudinal axis (and thus the positional relationship of the paper bag 300 and the jaw assemblies 102, 104). The direction of the operational axis 106 is into the page and is indicated by a cross inside a circle. In these examples, the first direction is indicated by the arrow 1202. As stated above, the separation between the paper bag longitudinal axis 301 and the operational axis 106 does not change, as described herein. In the examples of FIG. 12, the separation 1204 shown in FIG. 12 does not change substantially (within acceptable tolerances). For example, if the jaw assemblies 102, 104 move along the level change axis 318, the paper bag 300 moves correspondingly (as described further below) such that the separation 1204 is substantially (within acceptable tolerances) held constant. Even though the bag 300 may move towards the jaw assemblies 102, 104 as the mouth region 302 is folded, it may be desired that the positional relationship between the paper bag longitudinal axis 301 and the operational axis 106 does not change. Advantageously, this provides that there is consistency from one fold to the next as the rotation operation continues, even if the paper bag and the jaw assemblies are being moved together.

In other example (as described in further detail later) the paper bag longitudinal axis 301 may not be perpendicular to the level change axis 318. FIG. 13 shows some such examples from the same viewpoint as FIG. 12. In these examples, the first direction is indicated by the arrow 1302. The meaning of the separation between the paper bag longitudinal axis 301 and the operational axis 106 not changing, as described herein, is that the separation 1304 shown in FIG. 13 does not change substantially (within acceptable tolerances).

FIGS. 3a to 3f are schematic perspective views of the bag folding assembly 100 at different stages of interaction with a paper bag 300, according to examples. FIGS. 4a to 4f are schematic front on views of the bag folding assembly 100 at different stages of interaction with the paper bag 300, according to examples. In these examples, FIGS. 3a and 4a both correspond to a first stage during the interaction, FIGS. 3b and 4b both correspond to a second stage during the interaction, and so on.

FIG. 3a shows the relative orientation of a paper bag 300 and the bag folding assembly 100 in some examples where the paper bag 300 is oriented appropriately for interaction with the bag folding assembly 100. Other examples of the relative orientation are described later. FIG. 4a shows a corresponding schematic front on view, according to examples. FIG. 3a indicates the region 302 of the paper bag 300, which is the region 302 grasped by the first and second jaw assemblies 102, 104 as discussed above. The region 302 is the mouth region of the paper bag 300, for example. In the following examples, reference is made to the mouth region 302 of the paper bag 300. In these examples, the mouth region 302 is prepared such that it is formed into a flat mouth portion of the paper bag 300. The manner in which the flat mouth portion may be prepared is discussed further below.

In the examples of FIG. 3b, the paper bag 300 is in a jaw grasping position. FIG. 4b is a corresponding schematic front on view, according to examples. The jaw grasping position is a position at which the paper bag 300 is appropriately located for the first and second jaw assemblies 102, 104 to grasp the mouth region 302 of the paper bag 300. The jaw grasping position may be defined based on the specific arrangement and movement ranges of components of the bag folding assembly 100. As described, the first jaw assembly 102 and the second jaw assembly 104 are arranged with the jaws facing one another such that they are operable to grasp towards opposite edges of the mouth region 302 the paper bag 300. For example, the open mouth created by the jaws of the first jaw assembly 102 faces the open mouth created by the jaws of the second jaw assembly 104. The mouth region 302 has a first edge 304 and a second edge 306 on the opposite side to the first edge 304. In these examples, the first jaw assembly 102 is operable to grasp the region 302 towards the first edge 304 and the second jaw assembly is operable to grasp the region 302 towards the second edge 306.

As used herein, the term grasp towards a given edge means to grasp closer to that given edge than the edge opposite to that given edge. For example, the first jaw assembly 102 is operable to grasp the mouth region 302 closer to the first edge 304 than the second edge 306. Also, for example, the second jaw assembly 104 is operable to grasp the region 302 closer to the second edge 306 than the first edge 304.

FIG. 3c is a schematic perspective view of the bag folding assembly 100 and the paper bag 300 wherein the paper bag 300 is in the jaw grasping position and the first and second jaw assemblies 102, 104 are positioned such that the jaw assemblies can grasp towards the respective edges of the region 302, according to examples. FIG. 4c is a corresponding schematic front on view, according to examples. For example, starting from the relative positions of the first and second jaw assemblies 102, 104 shown in the examples of FIG. 3b, the first and second jaw assemblies 102, 104 move closer to one another to achieve the relative position shown in the examples of FIG. 3c. The first and second jaw assemblies 102, 104 move as indicated by arrows 305 and 307 respectively. The movement of the first and second jaw assemblies to move closer to one another is in opposite directions and parallel to the operational axis 106, in these examples. In the examples of FIG. 3c, with the paper bag 300 taking up in the jaw grasping position, the first edge 304 is positioned within the jaws of the first jaw assembly 102 and the second edge 306 is positioned within the jaws of the second jaw assembly 104. This positioning of the first and second jaw assemblies 102, 104 may be referred to as the operational separation. For example, the operational separation is a separation between the first and second jaw assemblies 102, 104 at which the jaw assemblies may first grasp the paper bag 300 as described herein.

In these examples, the first jaw assembly 102 comprises a first operational axis movement mechanism 309 and the second jaw assembly 104 comprises a second operational axis movement mechanism 311. The first and second operational axis movement mechanisms 309, 311 provide for movement of the respective jaw assemblies along the operational axis 106. For examples, the first operational axis movement mechanism 309 is configured to move the first jaw assembly 102 closer to and further away from the second jaw assembly 104 along the operational axis 106. For example, the second operational axis movement mechanism 311 is configured to move the second jaw assembly 104 closer to and further away from the first jaw assembly 102 along the operational axis 106. In these examples, each of the first and second operational axis movement mechanisms 309, 311 may comprise a respective base and a sliding mount mounted on the base in order to provide the described movement, for example. For example, the first and second operational axis movement mechanisms 309, 311 may be actuated by electrical motors. For example, the first and second operational axis movement mechanisms 309, 311 may utilize servo motors. In other examples, other way of providing actuation may be utilised. Those skilled in the art will appreciate the various ways in which components may be actuated to move in a particular manner. The movements of the first and second jaw assemblies 102, 104 along the operational axis 106 discussed herein are performed by the first and second operational axis movement mechanisms 309, 311, for example.

In the examples of FIG. 1, 2 and 3a to 3c discussed thus far, the first and second jaw assemblies 102, 104 are in the open configuration. For example, it can be seen in FIG. 3c that the jaws of the first and second jaw assemblies 102, 104 are open to an extent that they are spread apart from the mouth region 302 of the paper bag 300. In these examples, the first and second jaw assemblies 102, 104 transition from the open configuration as shown, into the closed configuration, shown in subsequent figures (discussed below), in order to grasp the region 302.

FIG. 3d is a schematic perspective view of the bag folding assembly 100 and the paper bag 300 wherein the first and second jaw assemblies 102, 104 grasp the region 302 of the paper bag 300. FIG. 4d is a corresponding schematic side view, according to examples. As shown in the examples of FIGS. 3d and 4d, the jaws of the first jaw assembly 102 have come together to grasp the region 302 towards the first edge 304 and the jaws of the second jaw assembly 104 have come together to grasp the region 302 towards the second edge 306. For example, the jaws of the second jaw assembly 104 move towards one another as indicated by arrow 306a and 306b. In these examples, the jaws of the second jaw assembly 104 pivot such that the distal ends of the jaws move closer to one another. In these examples, the distal ends of the jaws of the second jaw assembly 104 point away from the remainder of the second jaw assembly 104. In the described arrangement of the first and second jaw assemblies 102, 104 facing one another, the distal ends of the jaws of the second jaw assembly 104 are the ends closest to the first jaw assembly 102. The jaws of the first jaw assembly 102 move in the same manner, for example.

For example, the jaw assemblies may each comprise one or more motors (for example, servo motors) to provide movement of the jaws. For example, there may be provided one or more servo motors in each jaw assembly to provide for the transition between the open configuration and the closed configuration. In other examples, other actuation means may be provided, such as hydraulic systems, pneumatic systems, mechanical systems, and the like.

As previously described, the first and second jaw assemblies 102, 104 grasp the region 302 such that sliding of the region 302 of the paper bag relative to the jaw assemblies 102, 104 is inhibited. For example, in the closed configuration, the space between the pair of jaws of each jaw assembly is reduced to an extent that the mouth region 302 held therebetween is inhibited from sliding. In some examples, each pair of jaws grasps the region 302 such that sliding of the region 302 relative to the respective jaws is prevented. For example, sliding may not occur during the normal movements, in use, of the first and second jaw assemblies 102, 104. For example, the jaw assemblies 102, 104 may move with particular levels of speed and force during normal operation. The jaw assemblies may grasp the region 302 securely enough such that the region 302 does not slide relative to the jaw assemblies during movement with said particular levels of speed and force.

Accordingly, in some examples, sliding is merely inhibited. For example, sliding may be inhibited to a degree that the rotation operation can successfully be performed without the region 302 simply slipping out of the pairs of jaws during rotation. However, in these examples, sliding may not be entirely prevented. For example, while sliding may be inhibited to the extent that sliding substantially (within acceptable tolerances) does not occur during the rotation operation, the sliding is still not prevented so that sliding may occur when the first and second jaw assemblies 102, 104 move towards and away from the operational separation in the closed configuration when the rotation operation is not occurring. For example, while grasping the mouth region 302 in the closed configuration, in some examples, it is possible to pull the jaw assemblies away from the mouth region 302 due to sliding, without deviating from the closed configuration and after the rotation operation, as further described below.

As previously described, the first jaw assembly 102 and the second jaw assembly 104 are configured to simultaneously rotate about the operational axis 106 to fold the paper bag 300 by turning the region 302 of the paper bag 300. More specifically, the region 302 is folded so as to close up the paper bag 300, as described in further detail below. The movements involved in the simultaneous rotation to fold the region 302 are referred to as the rotation operation. It will be appreciated that, in use, the rotation operation is performed while the first and second jaw assemblies 102, 104 grasp the region 302 of the paper bag 300. Therefore, in the described examples, the first and second jaw assemblies 102, 104 are configured to perform the rotation operation while in the closed configuration.

More specifically, for example, the pair of jaws of each jaw assembly 102, 104 undergoes rotation during the rotation operation. For example, each pair of jaws rotates in a manner such that after half a complete rotation, the lower and upper jaws trade places.

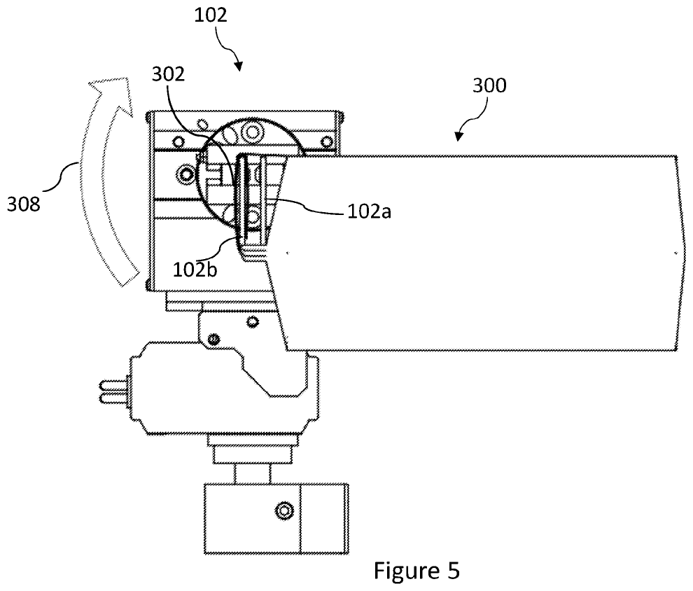

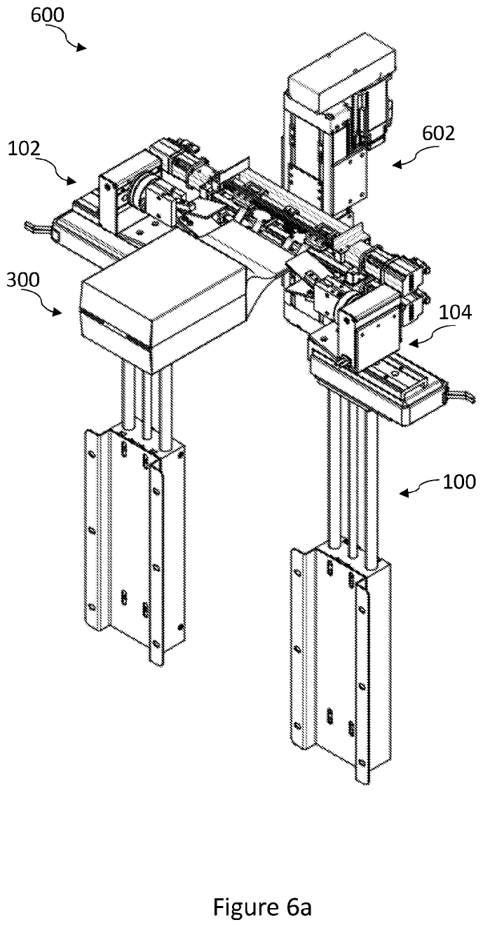

In these examples, the start of the rotation operation causes the region 302 to pivot towards the centre of the paper bag 300. In other words, the start of the rotation operation causes the longitudinal edge of the mouth region 302 of the paper bag 300 to pivot towards the centre of the paper bag 300. In this manner, the mouth region 302 of the paper bag is folded towards the centre of the paper bag 300. The curved arrows 308 and 310 shown in FIGS. 3d and 4d indicate an example direction of rotation. FIG. 5 shows a schematic side view of the first jaw assembly 102, according to examples, illustrating the result of the rotation operation. FIG. 5 is a cross-section taken through the paper bag 300 along the line A-A as indicated in FIG. 4e. In these examples, the direction of rotation is such that after a quarter rotation, the mouth region 302 faces upwards with respect to the orientation shown in FIGS. 3d and 4d.

In these examples, each jaw is a flat rectangular plate, as previously described (though in other examples, the jaws may be constructed differently). Due to the flat rectangular plates, the region 302 maintains a flat shape during the rotation operation, in these examples. In these examples, due to the flat rectangular shape, a series of longitudinal folds are created towards the mouth region 302 of the paper bag 300. The manner in which the mouth region 302 is folded may depend on the construction of the jaws, for example.

For example, as previously described, in relation to each of the jaws 102a, 102b, 104a, 104b, the operational axis 106 is positioned closer to one of the first and second lateral ends, as compared to the other of the first and second lateral ends. In the following description, it is assumed that the operational axis 106 is positioned closer to the first lateral ends as depicted in the examples of the Figures.

As previously described, while rotating about the operational axis 106, the second lateral ends would describe a larger rotation radius (in other words, a larger arc) than the first lateral ends. This has an advantageous effect on the way in which the fold of the mouth region 302 is created. In some examples, the operational axis is positioned closer to the first lateral end of each jaw; and a first space created between the first lateral end of each jaw and the region of the paper bag during the rotation operation is greater than a second space created between the second lateral end of each jaw and the region of the paper bag during the rotation operation.

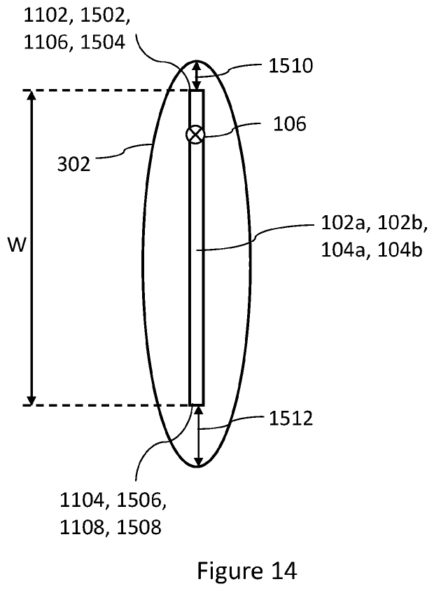

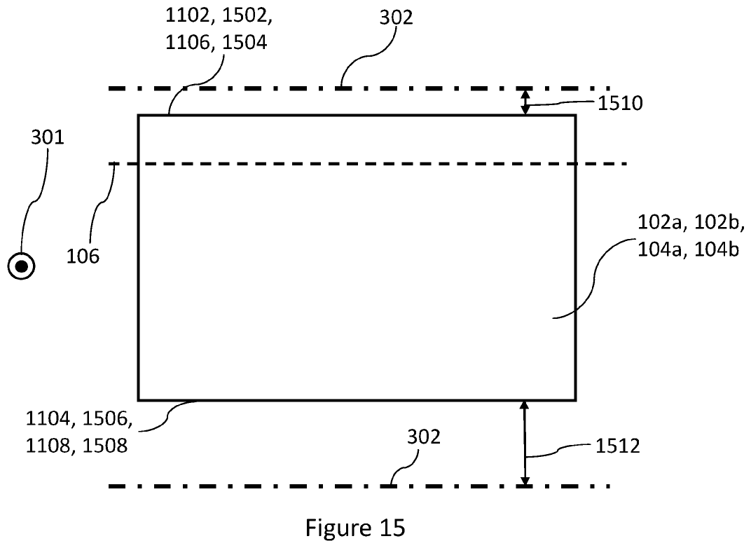

FIG. 14 is a schematic side view as viewed along the operational axis 106, according to examples. FIG. 15 is a schematic front cross-sectional view as viewed along the paper bag longitudinal axis 301. FIGS. 14 and 15 show a similar folded state to that shown in the examples of FIG. 5, but with greater detail of the fold as described in the following. For simplicity, only a single jaw is shown in FIGS. 14 and 15. In FIG. 15, the material of the mouth region 302 of the paper bag 300 is depicted in dash-dot lines. The jaw shown may be any one of the first, second, third and fourth jaws. The reference numerals 1502 and 1504 correspond to first lateral ends, respectively, of the second and fourth jaws 102b, 104b. The reference numerals 1506 and 1508 correspond to the second lateral ends, respectively, of the second and fourth jaws 102b, 104b.

As a consequence of the position of the operational axis 106 relative to the width W of the jaws, and as a result of the rotation operation, the first space 1510 between the material of the folded mouth region 302 and the first lateral ends 1102, 1502, 1106, 1504 is less than the second space 1512. Accordingly, there is provided more space between the material of the mouth region 302 and one of the lateral ends of each jaw. This space advantageously provides that the jaws 102a, 102b, 104a, 104b can be retracted (in other words, the first and second jaw assemblies 102, 104 can be moved apart from one another), while the jaws are in the closed configured in a way so that the folded mouth region 302 is substantially (within acceptable tolerances) not disturbed or damaged. For example, this manner of operation may work together with the example features that sliding of the mouth region 302 relative to the closed configuration jaws is merely inhibited (but not prevented, entirely) such that the jaws can be pulled away while in the closed configuration without disturbing or damaging the folded mouth region 302. In these examples, the jaws 102a, 102b, 104a, 104b may not be opened slightly compared to the closed configuration in order to retract the jaws. In other words, the first and second jaw assemblies 102, 104 can remain in the closed configuration and not deviate from the closed configured in order for the jaws to be retracted. The advantage of such examples is that the fold is not disturbed due to a movement of the jaws to deviate slightly from the closed configuration.

FIG. 3e is a schematic perspective view of the of the bag folding assembly 100 and the paper bag 300 wherein the rotation operation has been completed, according to examples. FIG. 4e is a corresponding schematic side view, according to examples. In these examples, the rotation operation involves each pair of jaws rotating about the operational axis 106 by 450 degrees simultaneously. In other words, in the examples shown in the Figures, the jaws of each jaw assembly 102, 104 simultaneously rotate for 1 and a ¼ turn about the operational axis 106. In other examples, a different amount of rotation may be used. For example, the desired amount of rotation simply depends on how the closed bag is to be presented. In the examples shown, the folded mouth region 302 is folded up against the remainder of the bag 300, for example, as shown in FIG. 3e. In such examples, the folded mouth region 302 may be secured against the remainder of the paper bag 300 by a sticky label, a staple, tape and the like, for example. In the examples of FIGS. 3e and 4e, the folded mouth region 302 is secured to the remainder of the paper bag 302 by a label 316. To create this kind of fold in the mouth region 302, the rotation operation may involve rotation by an integer multiple of a full turn plus a ¼ or a ¾ turn.

In some examples, it may be desired that the folded mouth region 302 protrude outwardly from the remainder of the paper bag 300. In such examples, the folded mouth region 302 may form a tab which protrudes from the paper bag 300. Such a tab may be used by a user to manipulate or hold onto the paper bag 300. In such examples, the rotation operation may involve an integer multiple of half a turn. For example, a 360 degree rotation, a 540 degree rotation, etc., may provide folded mouth portion 302 as a tab. Accordingly, the amount of rotation appropriate to use in the rotation operation may be selected according to the desired end result for the packaged paper bag 300.

In some examples, the rotation operation comprises any rotation comprising an integer number of turns, a fractional number of turns or a combination of an integer number of turns and a fractional number of turns. In some examples, the first and second jaw assemblies 102, 104 are configured such that the rotation of the rotation operation is controlled to a high precision (for example, one degree up to a few degrees). For example, the rotation operation may be driven by motors with adequate precision. For example, servo motors may be used which can be finely controlled.

As previously described, the first and second jaw assemblies 102, 104 grasp the region 302 such that relative sliding of the region 302 is inhibited. In use, the rotation operation is performed while the first and second jaw assemblies 102, 104 are in the closed configuration and the mouth region 302 is grasped by the first and second jaw assemblies 102, 104, for example. Therefore, during the rotation operation, sliding (relative to the first jaw assembly 102) of the part of the region 302 towards the first edge 304 grasped by the first jaw assembly 102 is inhibited. Also, during the rotation operation, relative sliding of the part of the region 302 towards the second edge 306 grasped by the second jaw assembly 104 is also inhibited. As described, in some examples, the sliding is inhibited to an extent that relative sliding does not occur while the rotation operation is ongoing. Advantageously, therefore, the folding of the mouth region 302 can be well controlled resulting in neat and tidy folds in the mouth region 302. For example, the folds created in the mouth region 302 may also be tighter as compared to a case in which the region 302 can slide within the jaws while grasped.

In examples where the relative sliding is merely inhibited, but not entirely prevented. The relative sliding may not occur during the rotation operation, but relative sliding to retract the jaw assemblies 102, 104 away from one another may occur once the rotation has stopped. For example, during the rotation operation, enough grip may be generated, by virtue of the rotation, between the jaws 102a, 102b, 104a, 104b and the mouth region 302 being folded that relative sliding does not occur even if the first and second jaw assemblies 102, 104 move away from another. However, once the rotation has stopped and the associated gripping forces are removed, relative sliding may readily occur when the first and second jaw assemblies 102, 104 are moved away from another in the closed configuration.

In some examples, the operational axis 106 being positioned closer to one lateral end of each jaw relative to the other end may assist in the function of not allowing sliding during rotation, but allowing sliding in the closed configuration once the rotation has ceased. For example, enough grip may be generated during the rotation operation between the first lateral ends 1102, 1502, 1106, 1504 (in examples where the operational axis 106 is closer to said ends), and the mouth region 302 to not allow relative sliding when the first and second jaw assemblies 102, 104 are slightly moved apart. On the other hand, the effect of the larger gap between the second lateral ends 1104, 1506, 1108, 1508 providing for the relative sliding may dominate once the rotation has stopped.

For example, in use, during the rotation operation, the part of the region 302 towards the first edge 304 grasped by the first jaw assembly 102 substantially does not slide relative to the first jaw assembly 102. For example, in use, during the rotation operation, the part of the region 302 towards the second edge 306 grasped by the second jaw assembly 104 substantially does not slide relative to the second jaw assembly 104. In such examples, sliding is inhibited to a degree that sliding substantially does not occur (as opposed to inhibiting to a lesser degree such that sliding is hindered or reduced, but not substantially prevented). In such examples, advantageously, the folds created in the mouth region 302 may be even more well controlled, allowing the folds to be even more neat, tidy and/or tighter.

In some examples, each jaw assembly 102, 104 is configured to grasp the region 302 of the paper bag 300 such that sliding of the region 302 of the paper bag 300 relative to the respective jaw assembly is prevented during the simultaneous rotation about the operational axis 106, and is prevented even after the rotation operation when the jaw assemblies 102, 104 are in the closed configuration.

In some examples, the jaw assemblies 102, 104 are configured to move away from one another during the rotation operation. For example, the first and second jaw assemblies 102, 104 are configured to move away from each other when they are in the closed configuration and during the time that the rotation operation is occurring. For example, in use, this means that the first and second jaw assemblies 102, 104 pull apart the mouth region 302 during the rotation operation. For example, the first and second jaw assemblies 102, 104 moving away from one another increases tension in the longitudinal direction in the mouth region 302. Referring to FIGS. 3d and 4d, the movement of the first and second jaw assemblies 102, 104 moving away from one another is indicated by arrows 312 and 314 respectively. The movement apart of the first and second jaw assemblies 102, 104 is in opposite directions parallel to the operational axis 106, in these examples. Referring to the orientation shown in FIG. 4d, the first jaw assembly 102 moves to the left while the second jaw assembly moves to the right in this particular orientation, for example.

It will be understood that when relative sliding of the mouth region 302 and the closed configuration jaw assemblies 102, 104 is prevented (rather than inhibited) tension will be created in the mouth region 302. However, even in the examples where the relative sliding is inhibited to a degree that it does not occur during the rotation operation but may occur thereafter, such tension may also be created to pull apart the first and second edges 304, 306 of the mouth region 302 of the paper bag 300. Accordingly, the advantageous effect of creating tension may be achieved in either sets of examples.

In some examples, the jaw assemblies 102, 104 are configured to move away from one another in a continuous manner during the rotation operation. For example, the jaw assemblies 102, 104 may move away from one another at a non-zero rate during the rotation operation. In some such examples, the movement away from one another may occur at a constant rate. In some such examples, the movement away from one another may occur at a rate which varies during the rotation operation. In this manner, the level of tension created in the longitudinal direction of the mouth region 302 may be controlled throughout the rotation operation.

In some examples, the jaw assemblies 102, 104 are configured to move away from one another in a step-wise manner during the rotation operation. For example, the first and second jaw assemblies 102, 104 may move away from one another in discrete steps during the rotation operation. For example, the movement may comprise one or more steps which occur during the rotation operation. In some examples, the first and second jaw assemblies 102, 104 move away from one another in two discrete steps, or in three discrete steps, or in four discrete steps, or in five discrete steps, and the like. During each step, the first and second jaw assemblies 102, 104 move away from one another at a given rate, for example. The rate of movement (e.g., as may be expressed in units of distance per unit time) may be selected so as to provide the desired increase in tension in the region 302 during the respective step without, for example, tearing or otherwise damaging the region 302. The rate of movement during a given step may be constant, for example. The rate of movement during a given step may be variable, for example. Each step may occur over a period of time according to the distance the jaw assemblies are to move apart and the amount of time over which that movement is to occur, for example.

The first and second jaw assemblies 102, 104 moving away from one another in any of the described ways, during the rotation operation may advantageously result in neat and consistent folds in the mouth region 302. For example, when the mouth region 302 is held taught when being folded, neat folds may be created. Furthermore, the folds may be created in a more controlled and consistent manner such that a predictable quality of folds can be provided.

As previously described, the jaws of each of the first and second jaw assemblies 102, 104 grasp the region 302. In some examples, each of the jaw assemblies 102, 104 comprise a gripping arrangement configured to generate friction between the jaws of the respective jaw assembly and the region 302 of the paper bag 300 when the region 302 of the paper bag 300 is grasped by the respective jaw assembly. For example, the gripping arrangement involves providing a structure, component and/or material on the jaw assembly which operates to generate friction between the respective jaw assembly and the region 302 when the respective jaw assembly grasps the region 302. For example, the first jaw assembly 102 comprises a first gripping arrangement 202 and the second jaw assembly 104 comprises a second gripping arrangement 204, as illustrated for example in FIG. 2. For example, the gripping arrangement may be provided in examples where relative sliding of the mouth region 302 relative to the closed configuration jaws is to be prevented as opposed to merely inhibited (e.g., even when the rotation operation is not occurring).

In some examples, the gripping arrangement 202, 204 comprises a high friction member provided on each jaw. In such examples, the high friction member is configured to contact the region 302 of the paper bag 300 when the respective jaw assembly grasps the region 302 of the paper bag 300. Referring again to FIG. 2, for example, there is provided the first gripping arrangement 202 on the first jaw assembly 102 and the second gripping arrangement 204 on the second jaw assembly 104.

In these examples, the first gripping arrangement 202 comprises a first high friction member 202a and a second high friction member 202b. The first high friction member 202a is provided on the first jaw 102a. More specifically, the first high friction member 202a is provided on a surface of the first jaw 102a which faces the region 302 of the paper bag 300 in use. The surface of the first jaw 102a which faces the region 302 may be referred to as the paper bag facing surface. The first high friction member 202a is provided at a location on the first jaw 102a where the first high friction member 202a would make contact with the region 302 when the first jaw assembly 102 transitions to the closed configuration to grasp the region 302. For example, the first high friction member 202a is provided towards the distal end of the first jaw 102a. For example, the first high friction member 202a is dimensioned to cover at least a part of the paper bag facing surface of the first jaw 102a which overlaps the region 302 in use.

The second high friction member 202b may be provided on the second jaw 102b in a similar manner to that described above in relation to the first high friction member 202a. In these examples, the second gripping arrangement 204 comprises a third high friction member 204a and a fourth high friction member 204b. The third high friction member 204a may be provided on the third jaw 104a in a similar manner to that described above in relation to the first high friction member 202a. The fourth high friction member 204b may be provided on the fourth jaw 104b in a similar manner to that described above in relation to the first high friction member 202a.

For example, each of the high friction members 202a, 202b, 204a, 204b may be in the form of a piece of material fixed to the respective jaw. The high friction members 202a, 202b, 204a, 204b may have the same shapes and dimensions as each other, or the shapes and/or dimensions may vary among the high friction members 202a, 202b, 204a, 204b. The high friction members 202a, 202b, 204a, 204b may be composed of a material having a high coefficient of friction. For example, the coefficient of friction of the material used is higher relative to the coefficient of friction of the material comprised in the first, second, third and fourth jaws 102a, 102b, 104a, 104b. In examples where the bag folding assembly is for use in packaging food items in paper bags, the high friction members 202a, 202b, 204a, 204b may be composed of a food grade rubber. In other examples, other materials may be used.

In some examples, the high friction members 202a, 202b, 204a, 204b are provided in the form of a coating of high friction material applied towards the distal ends of the respective jaws 102a, 102b, 104a, 104b.

The described gripping arrangements 202, 204 are a specific way of providing that the jaw assemblies 102, 104 grasp the region 302 of the paper bag in a manner such that sliding of the region 302 relative to the jaw assemblies 102, 104 is inhibited up to and including to an extent that sliding may be prevented during normal use.

Those skilled in the art will appreciate that the bag folding assembly 100 may be used in conjunction with other machinery involved in packaging items into paper bags. In some examples, conveyors (e.g., systems in which items being packaged move along on a conveyor belt) may be used. In some examples, conveyors may be involved in the process to deliver the paper bag 300 into the jaw grasping position discussed above.

In some examples, it may be advantageous for the bag folding assembly 100 to move in a manner which corresponds to the journey of the paper bag 300 through the packaging process. For example, parts of the bag folding assembly 100 may not be stationary during the rotation operation. In some examples, the first and second jaw assemblies 102, 104 are configured to move with respect to a level change axis simultaneously, wherein the level change axis is perpendicular to the operational axis 106. The orientation of the level change axis 318 is indicated in FIGS. 3a to 3f and FIGS. 4a to 4f.

Referring to the examples shown in FIGS. 3a, 3b, 4a and 4b, the paper bag 300 is shown in the jaw grasping position. In the examples of FIGS. 3a and 4a, the first and second jaw assemblies 102, 104 are in a lower position than the jaw grasping position (in the orientation shown in these Figures) with respect to the level change axis 318. This lower position may be referred to as the lower jaw assembly position. In the examples of FIGS. 3b and 4b, the first and second jaw assemblies 102, 104 are in a position, with respect to the level change axis 318, which is aligned with the jaw grasping position with respect to the level change axis 318. For example, in the examples of FIGS. 3b and 4b, the jaw assemblies have moved upwards along the level change axis 318 as compared to FIGS. 3a and 4a. The position aligned with the jaw grasping position with respect to the level change axis 318 may be referred to as the upper jaw assembly position. It will be appreciated that movement of the first and second jaw assemblies with respect to the operational axis 106 only does not result in a change in position with respect to the level change axis 318, for example. Accordingly, when the first and second jaw assemblies 102, 104 move closer to one another or further apart, as described above, the upper jaw assembly position is maintained.

For example, respective level change mechanisms are provided in order to change the position of the first and second jaw assemblies 102, 104 with respect to the level change axis. The mechanisms may comprise, motors such as servo motors, hydraulic systems, pneumatic systems, mechanical systems, and the like. In the examples of FIGS. 3a to 3f, and 4a to 4f, there is shown a first level change mechanism 313 for the first jaw assembly 102 and a second level change mechanism 315 for the second jaw assembly 104. In these examples, each level change mechanism has a base from which extending members (with the respective jaw assemblies mounted thereon) extend to move relative to the level change axis.

In these examples, the first and second jaw assemblies 102, 104 grasp the region 302 when in the upper jaw assembly position. In some examples, a transition from the upper jaw assembly position to the lower jaw assembly position may take place during the rotation operation. For example, the mouth region 302 is folded as described while the paper bag 300 moves relative to the level change axis 318. For example, the paper bag 300 may be supported on a packaging platform which moves correspondingly with the first and second jaw assemblies 102, 104 during transition from the upper jaw assembly position to the lower jaw assembly position.

However, as previously described, the separation between the paper bag longitudinal axis 301 and the operational axis 106 along the first direction remains substantially (within acceptable tolerances) constant during the rotation operation (where the first direction is perpendicular to the operational axis 106 and perpendicular to the paper bag longitudinal axis 301). It should be noted that the Figures are schematic in nature and illustrate some positions of the paper bag relative to the various assemblies in a simplistic manner. As already described, the mouth region 302 is folded as described while the paper bag 300 moves relative to the level change axis 318. For example, the paper bag 300 is supported on the packaging platform which moves correspondingly with the first and second jaw assemblies 102, 104 during transition from the upper jaw assembly position to the lower jaw assembly position. Because the packaging platform moves correspondingly with the first and second jaw assemblies 102, 104 during the transition from the upper jaw assembly position to the lower jaw assembly position while the rotation operation is occurring, it means that the operational axis 106 and the paper bag longitudinal axis 301 do not substantially (within acceptable tolerances) move further apart or closer together in a direction which is perpendicular to both the operational axis 106 and the paper bag longitudinal axis 301. As referred to herein, within acceptable tolerances means slight deviations between the synchronicity of movement between the first and second jaw assemblies 102, 104 and the packaging platform due to the manner of operation of said machinery may be acceptable. For example, the rotation operation takes place during the transition. In some examples, after the rotation operation has ceased, there may be a movement of the first and second jaw assemblies 102, 104 (e.g., deviating a little from the lower jaw assembly position) to press the folded mouth region 302 towards the remainder of the paper bag to assist in closing up the paper bag.

In these examples, it may be desired that the paper bag 300 interact with a piece of apparatus lower down than the jaw grasping position (with respect to the orientations shown in FIGS. 3a to 3f and 4a to 4f). In such examples, movement of the paper bag to such a lower position may take place at the same time as the described mouth region 302 folding operation. In this way, an efficient packaging process may advantageously be provided.

In some examples, each of the first and second jaw assemblies 102, 104 are configured to adopt a fold release configuration in which the respective jaws are marginally more open as compared to the closed configuration, such that, when the region 302 of the paper bag 300 is positioned between the respective jaws, the region 302 is able to readily slide relative to the respective jaw assembly. In some examples, the first and second jaw assemblies 102, 104 may be configured to adopt the fold release configuration after performing the rotation operation, and move apart from one another after adopting the fold release configuration. It will be understood that the fold release configuration may be used in examples where relative sliding of the mouth region 302 and the jaws is prevented (e.g., does not occur even after the rotation operation) rather than inhibited. However, as described above, in some examples, the jaw assemblies 102, 104 can be retracted while still in the closed configuration and the fold release configuration is not used.

In some examples, the fold release configuration is used to extract the jaws from the folds which have been created in the mouth region 302 in the rotation operation. Because in some examples, the jaw assemblies 102, 104 grasp the region 302 in a manner such that relative sliding is prevented, the jaws 102a, 102b, 104a, 104b may not be readily extracted after the rotation operation when in the closed configuration. In these examples, from the closed configuration, each pair of jaws opens slightly such that relative sliding of the region 302 is no longer inhibited to the degree that sliding does not occur even after the rotation operation has finished. Then the jaws may be extracted from the folded mouth region 302 by movement of the jaw assemblies 102, 104 away from one another. For example, the jaws may be extracted in the fold release configuration rather than returning to the open configuration so that the folded mouth region 302 does not unfold.

FIG. 3f is a schematic perspective view of the bag folding assembly 100 and the paper bag 300 wherein the first and second jaw assemblies 102, 104 have moved away from one another along the operational axis 106 after having completed the rotation operation and when in the fold release configuration, according to examples. FIG. 4f is a corresponding schematic side view, according to examples. In FIGS. 3f and 4f, the arrow 312 indicates the movement of the first jaw assembly with respect to the operational axis 106, and the arrow 314 indicates the movement of the second jaw assembly 104 with respect to the operational axis 106 when the jaws are being extracted from the folded mouth region 302.

It will be appreciated that the type of fold created by the jaws 102a, 102b, 104a, 104b will depend at least in part on the structure of the jaws. For example, larger or smaller folds may be created depending on the width W of each jaw. In some examples, the bag folding assembly 100 is provided in a manner such that each jaw is detachably connected to its respective jaw assembly. For example, each of the first, second, third and fourth jaws 102a, 102b, 104a, 104b may be detachably connected such that they can be detached and remove from the respective assemblies.

For example, each jaw assembly comprises a jaw detachable connection mechanism configured to allow a user to manually detach and re-attach jaws onto the respective jaw assembly. The detachable connection mechanism is robust enough such that the jaws are locked in place and do not detach during normal operation. Those skilled in the art will appreciate the various ways in which two elements may be detachably connected. For example, a pop-pin mechanism, a spring-loaded locking mechanism, a friction fit mechanism, a magnetic detachable connection mechanism, a clip mechanism, and the like may be used.

Advantageously, by allowing users to detach the jaws, the bag folding assembly 100 may provide flexibility in terms of being able to create different kinds of folds. For example, there may be provided a bag folding system for a packaging apparatus preparing a paper bag to be closed, the bag folding system comprising: the bag folding assembly having a facility that each jaw is detachably connected to its respective jaw assembly. For example, the bag folding system may comprise a plurality of sets of jaws, wherein each set of jaws comprises jaws having a width different to the widths of the jaws of the other sets of jaws in the plurality of sets of jaws. For example, a number of sets of four jaws may be provided, where each set has jaws of a different width. In this manner, the user may connect a set of jaws according to a desired jaw width W to create the desired kind of fold.

In some examples, there may be provided a packaging apparatus for preparing a paper bag to be closed. For example, the packaging apparatus comprises the bag folding assembly 100 according to any of the described examples, wherein the region 302 of the paper bag 300 is the mouth region as previously described. For example, the packaging apparatus comprises a mouth preparation finger assembly comprising a plurality of fingers in the form of elongate members for performing a mouth preparation operation to prepare the mouth region 302 of the paper bag 300 such that it is formed into a flat mouth portion of the paper bag. For example, the bag folding assembly is configured to grasp the flat mouth portion (as described above) resulting from the mouth preparation operation performed by the mouth preparation finger assembly.

FIG. 6a is a schematic perspective view of a packaging apparatus 600 and the paper bag 300, according to examples. There is shown the bag folding apparatus 100 and a mouth preparation finger assembly 602, as described. FIG. 6a shows a stage at which the mouth preparation finger assembly 602 has prepared the mouth region 302 into the described flat mouth portion, and the first and second jaw assemblies 102, 104 are at a separation greater than the described operational separation (the separation relative to the operational axis 106 at which the jaw assemblies can interact with the mouth region 302).

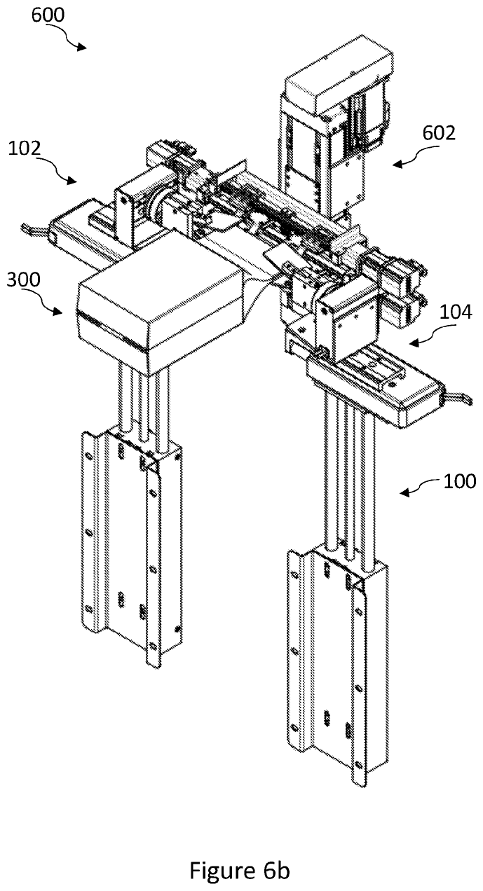

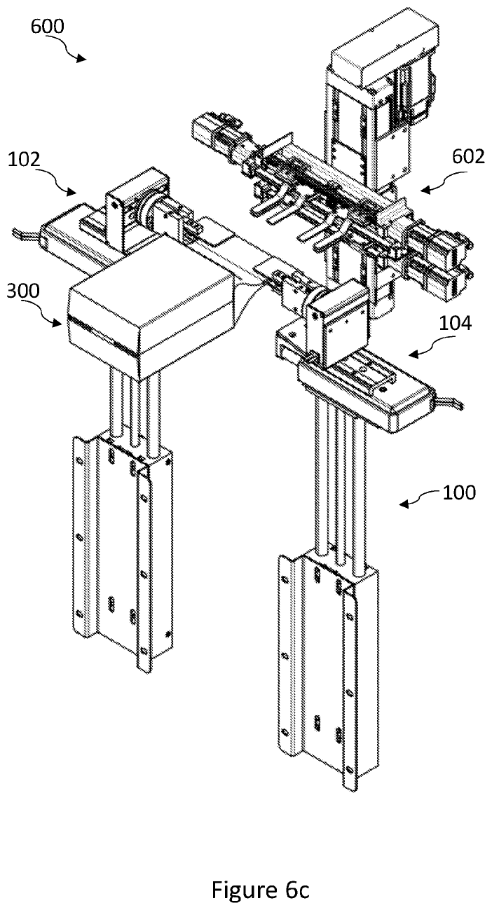

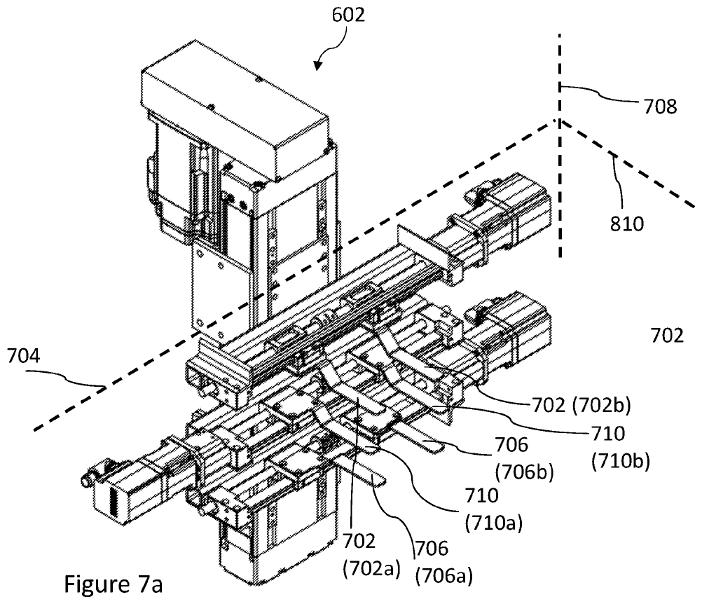

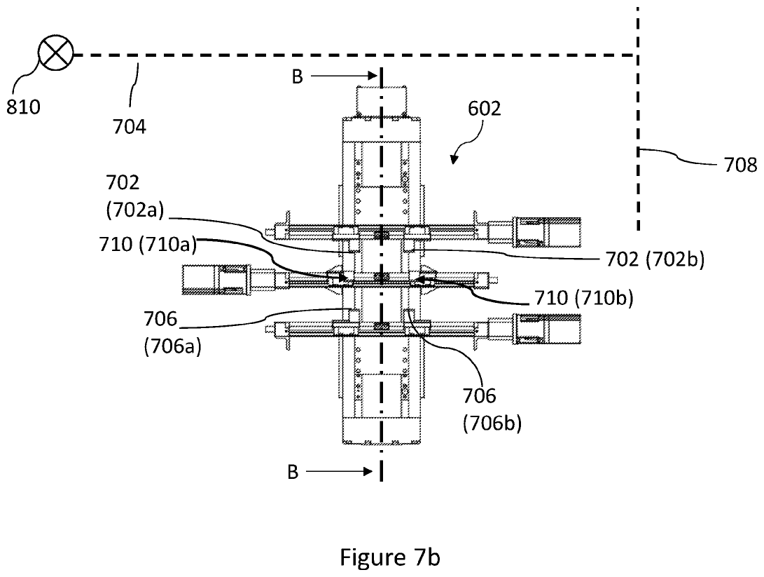

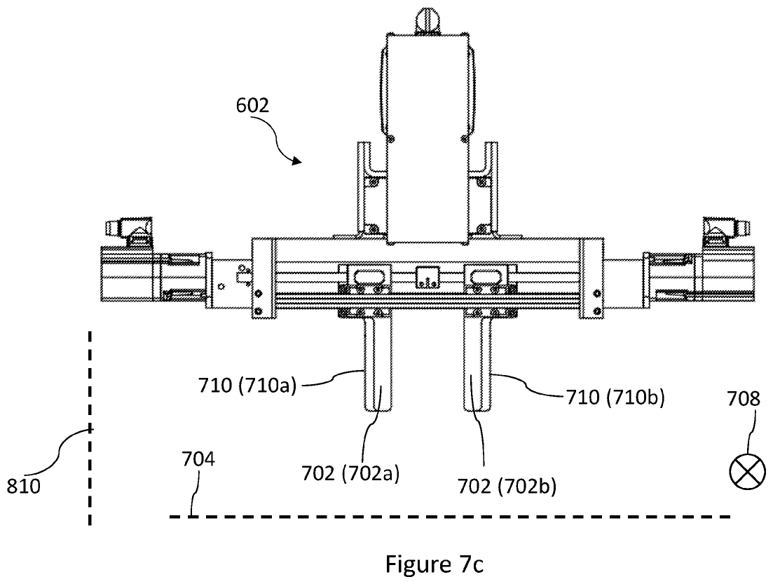

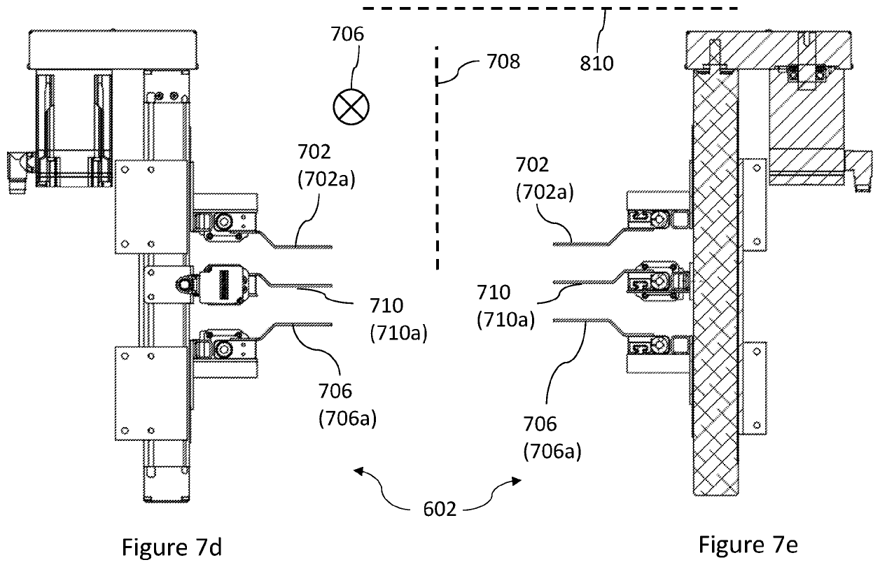

More specific examples of the mouth preparation finger assembly 602 will now be described. FIG. 7a is a schematic perspective view of the mouth preparation finger assembly 602, according to examples. In these examples, the mouth preparation finger assembly 602 (hereafter simply referred to as the finger assembly 602 for brevity) comprises a first pair 702 of inner fingers. For example, the first pair 702 of inner fingers comprises a first inner finger 702a and a second inner finger 702b. In these examples, the inner finger 702a, 702b of the first pair 702 are spaced apart from one another with respect to a first axis 704. In examples where the finger assembly 602 is arranged, in use, to work together with the bag folding assembly 100, the first axis 704 is substantially parallel to the operational axis 106.

In these examples, the finger assembly 602 also comprises a second pair 706 of inner fingers, and a pair 710 of outer fingers. For example, the second pair 706 of inner fingers comprises a third inner finger 706a and a fourth inner finger 706b. For example, the inner fingers 706a, 706b of the second pair 706 are spaced apart from one another with respect to the first axis 704. In these examples, the first pair of inner fingers 702 is spaced apart from the second pair of inner fingers 706 with respect to a second axis 708 which is perpendicular to the first axis 704.

In these examples, the pair 710 of outer fingers comprises a first outer finger 710a and a second outer finger 710b. In these examples, the outer fingers 710a, 710b are spaced apart from one another with respect to the first axis 704. In these examples, the position of the outer fingers 710a, 710b with respect to the second axis 708 is between the position of the first pair 702 of inner fingers and the second pair 706 of inner fingers with respect to the second axis 708.

FIG. 7b is a schematic front on view of the finger assembly 602, according to examples. In the orientation of FIG. 7b, both the first axis 704 and the second axis 708 lie within the plane of the page. For example, in the orientation shown in FIG. 7b, the first inner finger 702a is spaced apart from the second inner finger 702b in the horizontal (left to right) direction. In the orientation of FIG. 7b, the third inner finger 706a is also spaced apart from the fourth inner finger 706b in the horizontal direction. In the orientation shown in FIG. 7b, the pair 710 of outer fingers is between the first pair 702 of inner fingers and the second pair 706 of inner fingers with respect to the vertical direction.

FIG. 7c is a schematic plan view of the finger assembly 602, according to examples. In the orientation of FIG. 7c, the second axis 708 points into the page and is represented by a cross inside a circle (representing the rear of an arrow). FIG. 7d is a schematic side view of the finger assembly 602, according to examples. FIG. 7e is a schematic side cross-section view of the finger assembly 602, according to examples. The cross-section shown in FIG. 7e is taken along the line B-B indicated in FIG. 7b.

As described above, the plurality of fingers of the finger assembly 602 perform the mouth preparation operation, for example. In some examples, the mouth preparation operation comprises moving from an insertion configuration to a mouth opening configuration to open up the mouth of the paper bag 300. In these examples, the mouth preparation operation also comprises moving from the mouth opening configuration to a mouth flattening configuration to create the flat mouth portion of the paper bag 300.

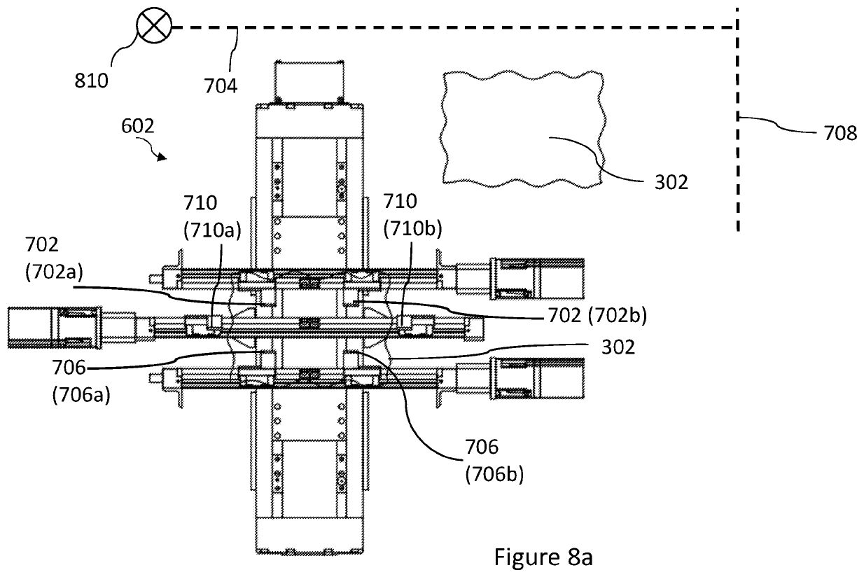

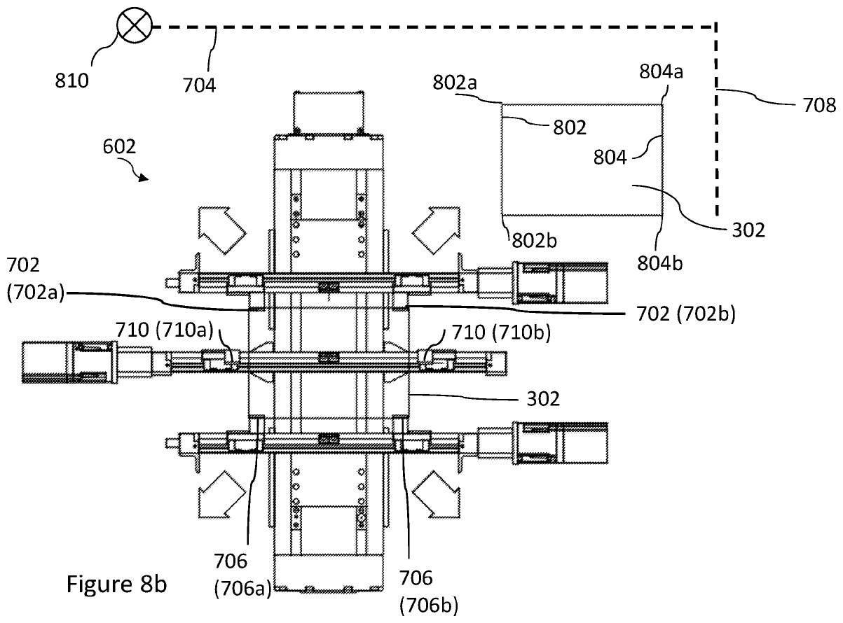

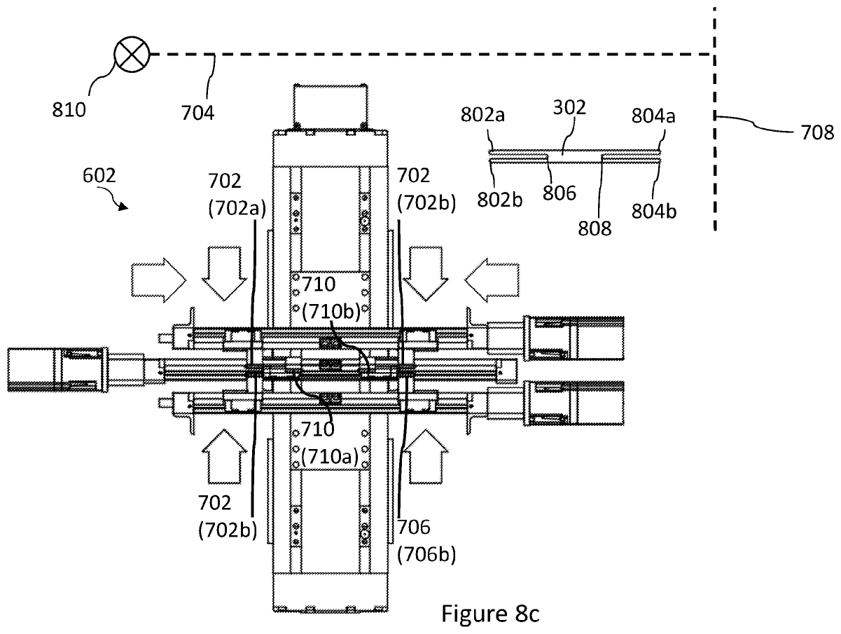

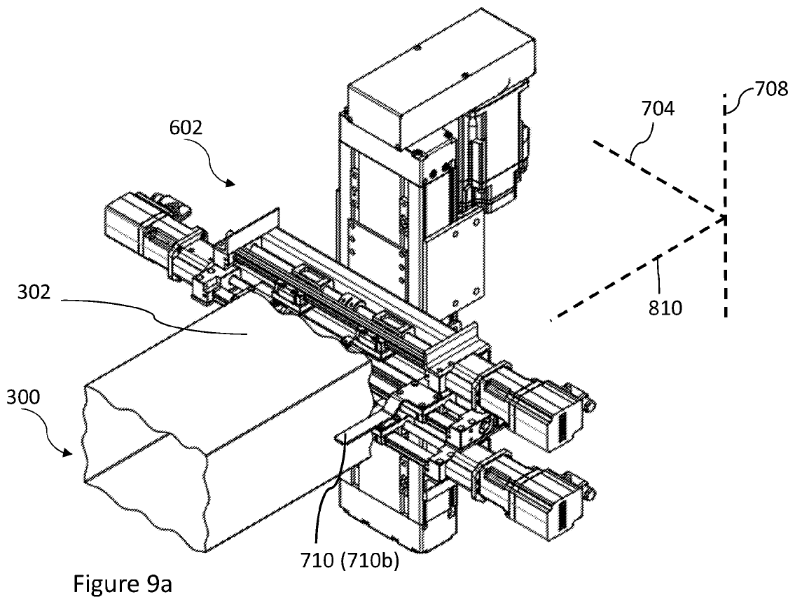

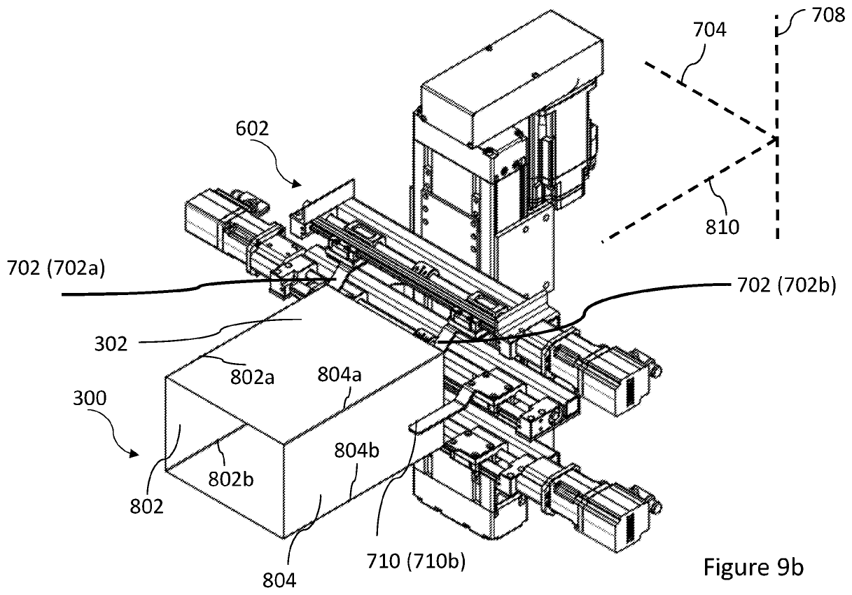

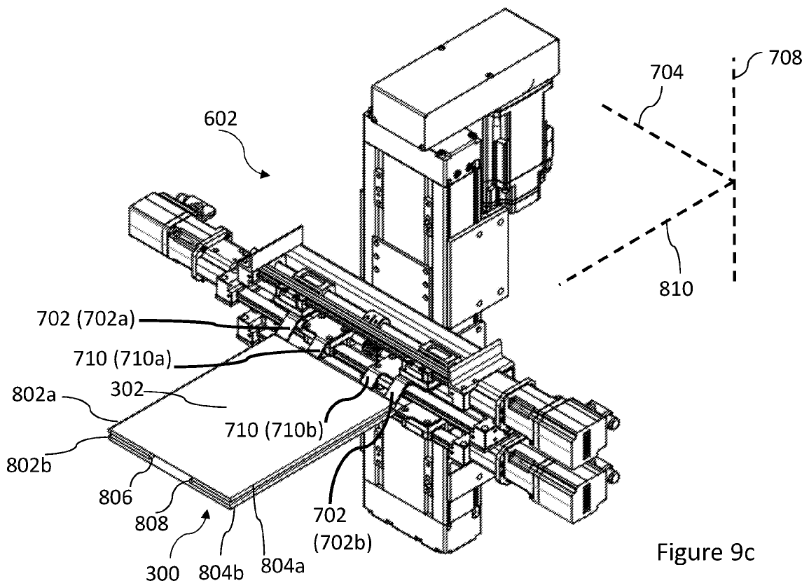

The insertion configuration is a configuration of the fingers of the finger assembly 602 used for initiating the interaction with the paper bag 300. FIG. 8a is a schematic front on view of the finger assembly 602 in the insertion configuration and the paper bag 300, according to examples. In the examples of FIG. 8a, an outline of the mouth region 302 of the paper bag 300 is shown. For the purpose of illustration, the outline of the mouth region 302 is also shown separate from the finger assembly 602 to illustrate the state of the mouth region 302 in the examples of FIG. 8a. FIG. 9a is a schematic perspective view of the finger assembly 602 in the insertion configuration and the paper bag 300, according to examples. In the examples of FIGS. 8a and 9a, some of the fingers of the finger assembly 602 are inserted into the mouth region 302. In other words, in these examples, the finger assembly 602 is engaged with the mouth region 302 of the paper bag 300.

In these examples, in the insertion configuration, the position of the first pair 702 of inner fingers 702a, 702b and the second pair 706 of inner fingers 706a, 706b with respect to the first axis 704 is between the position of the outer fingers 710a, 710b with respect to the first axis 704. In other words, all the inner fingers are closer to one another with respect to the first axis 704 compared to the outer fingers 710a, 710b because the first outer finger 710a is further away from the second outer finger 710b. In other words, the outer fingers 710a, 710b are on the outside of all the inner fingers with respect to the first axis 704.

In some examples, the finger assembly 602 approaches the mouth region 302 in the insertion configuration. In some other examples, it is the paper bag 300 which is moved so that the mouth region 302 approaches the finger assembly 602 when in the insertion configuration. In these examples, the insertion configuration is such that all the inner fingers 702a, 702b, 706a, 706b are readily inserted into the paper bag 300, while the outer fingers 710a, 710b remain outside the paper bag 300, for example as shown in FIG. 9a. For example, in the insertion configuration, the inner fingers 702a, 702b, 706a, 706b are close enough to one another such that they do not contact the material of the paper bag 300 when inserting into the mouth region 302. It should be noted that the inner fingers 702a, 702b, 706a, 706b are also close enough to one another with respect to the second axis 708 such that contact with the material of the paper bag 300 is avoided. It will be appreciated that the distances of the insertion configuration may be selected based on the specific paper bag for which the finger assembly 602 is to be used.

For example, the insertion configuration is adopted so that the fingers are in an appropriate initial position relative to the mouth region 302 for manipulating the mouth region 302 of the paper bag 300. In some examples, the finger assembly 602 comprises an air blower (not shown in the Figures) configured to blow air towards the mouth region 302 immediately before the mouth region 302 reaches the finger assembly 602. For example, in either example of the finger assembly 602 moving towards the paper bag 300, or the paper bag 300 moving towards the finger assembly 602, the air blower is timed such that air is blown at the mouth region 302 at an appropriate time so that the mouth region 302 opens to aid insertion of the inner fingers 702a, 702b, 706a, 706b. Those skilled in the art will appreciate the mechanisms which can be provided to generate a puff of air. For example, an air containing resiliently deformable chamber may be compressed in order to blow air, and the like. The air blower incorporated in the finger assembly 602 advantageously increases the reliability of the appropriate finger being correctly inserted into the mouth region 302.

After the finger assembly 602 is engaged with the mouth region 302 in the insertion configuration, as shown in FIGS. 8a and 9a, the finger assembly transitions from the insertion configuration to the mouth opening configuration, for example.

The function of the transition to the mouth opening configuration is to stretch and open out the mouth region 302, before further manipulating the mouth region 302. In some examples, the mouth preparation finger assembly 602 is configured such that each of the inner fingers 702a, 702b, 706a, 706b moves away from the other inner fingers 702a, 702b, 706a, 706b in a plane defined by the second axis 708 and the first axis 704 to move from the insertion configuration to the mouth opening configuration. For example, the first inner finger 702a moves away from the remaining inner fingers 702b, 706a, 706b with respect to the first axis 704 and with respect to the second axis 708. The other inner fingers 702b, 706a, 706b move in a corresponding manner. For example, the inner fingers 702a, 702b, 706a, 706b define a rectangle of a first size in the insertion configuration. When the transition to the mouth opening configuration is completed, the inner fingers 702a, 702b, 706a, 706b define a rectangle of a second size large than the first size.

FIG. 8b is a schematic front on view of the finger assembly 602 in the mouth opening configuration, according to examples. As can be seen in FIG. 8b, there are large arrows indicating an example of the movement of the inner fingers 702a, 702b, 706a, 706b to arrive at the mouth opening configuration. The inner fingers 702a, 702b, 706a, 706b may take any path to arrive at the mouth opening configuration. In some examples, each inner finger 702a, 702b, 706a, 706b first moves relative to the first axis 704 and then relative to the second axis 708. In some other examples, each inner finger 702a, 702b, 706a, 706b first moves relative to the second axis 708 and then relative to the first axis 704. Alternatively, in some examples, the finger assembly 602 is configured such that during the movement from the insertion configuration to the mouth opening configuration, each of the inner fingers 702a, 702b, 706a, 706b move with respect to the second axis 708 and the first axis 704 simultaneously. For example, in the orientation shown in FIG. 8b, the inner fingers 702a, 702b, 706a, 706b move diagonally away from one another.

The movement to the mouth opening configuration causes the inner fingers 702a, 702b, 706a, 706b to interact with the mouth region 302 such that the paper is pulled taught by the inner fingers 702a, 702b, 706a, 706b and the mouth region 302 is opened to define a rectangle. FIG. 9b is a schematic perspective view of the finger assembly 602 in the mouth opening configuration, according to examples. FIG. 9b shows the effect on the mouth region 302 when the inner fingers 702a, 702b, 706a, 706b move to the mouth opening configuration. The effect, as described, is that the mouth region 302 is opened into a rectangular shape.

As previously described, the finger assembly 602 is configured to move from the mouth opening configuration to the mouth flattening configuration, for example. In some examples, in order to create the flat mouth portion of the paper bag 300, the finger assembly 602 is configured to manipulate the mouth region 302 so as to create an inward fold in a first side 802 (see FIGS. 8b and 9b) of the paper bag 300 and bring together the corners 802a, 802b of the first side 802 of the paper bag 300 at the mouth region 302. Also in these examples, the finger assembly 602 is configured to manipulate the mouth region 302 so as to create an inward fold in a second side 804 of the paper bag 300 and bring together the corners of the second side 804 of the paper bag 300 at the mouth region 302.

In the examples described with respect to FIGS. 8a, 8b, 9a and 9b, the mouth flattening configuration to create the flat mouth portion may be achieved in the following manner. FIG. 8c is a schematic front on view of the finger assembly 602 in the mouth flattening configuration, according to examples. FIG. 9c is a schematic perspective view of the finger assembly 602 in the mouth flattening configuration, according to examples.

In these examples, the finger assembly 602 is configured such that the first pair 702 of inner fingers 702a, 702b moves closer to the second pair 706 of inner fingers 706a, 706b with respect to the second axis 708. Furthermore, the outer fingers 710a, 710b move closer to one another. These movements cause all the fingers to move from the mouth opening configuration to the mouth flattening configuration.

For example, the first pair 702 of inner fingers 702a, 702b move downwards in the orientation of FIG. 8c as indicated by the downward pointing arrows. For example, the second pair 706 of inner fingers 706a, 706b move upwards in the orientation of FIG. 8c as indicated by the upward pointing arrows. For example, the first outer finger 710a moves to the right in the orientation shown in FIG. 8c. For example, the second outer finger 710b moves to the left in the orientation shown in FIG. 8c. The outer finger 710a, 710b cause the first and second sides 802, 804 to bend inwards as the inner fingers 702a, 702b, 706a, 706b bring together the corners 802a, 802b, 804a, 804b. For example, the first outer finger 710a passes between the first inner finger 702a and the third inner finger 706a. Also, for example, the second outer finger 710b passes between the second inner finger 702b and the fourth inner finger 706b. Accordingly, a first inward fold 806 and a second inward fold 808 is created as indicated in FIG. 8c. In this manner, the flat mouth portion is created in these examples.

In some examples, the finger assembly 602 is configured to grasp the flat mouth portion, when in the mouth flattening configuration, such that movement of the flat mouth portion relative to the finger assembly 602 along a third axis 810 is inhibited. The third axis 810 is perpendicular to the second axis 708 and perpendicular to the first axis 704. In the examples of FIGS. 8a to 8c, the third axis points into the page as indicated by a cross inside of a circle. It should be noted that the indications of the first, second and third axes 704, 708, 810 in the drawing indicate merely the orientation of these axis and not necessarily specific negative and positive directions or specific positions relative to the finger assembly 602, for example.

For example, when engaged with the flat mouth portion in the mouth flattening configuration, the finger assembly 602 may be used to move the flat mouth portion along the third axis 810. In some examples, there is enough tension created in the flat mouth portion such that the flat mouth portion does not slip relative to the fingers of the finger assembly 602 in the mouth flattening configuration. In some examples, the surface of one or more of the fingers of the finger assembly 602 are configured with a high friction coefficient such that slipping relative to the paper bag 300 is at least inhibited (e.g., prevented). For example, one or more of the first pair 702 of inner fingers 702a, 702b, second pair 706 of inner fingers 706a, 706b and the pair 710 of outer fingers 710a, 710b comprises a friction coating for creating friction between the respective fingers and the material of the paper bag 300.

The friction coating may comprise rubber, or another high friction coefficient material, for example. In some examples, food grade rubber is used. In some examples, the friction coating is provided on the first and second outer fingers 710a, 710b. For example, the friction coating may cover a region of the respective fingers intended to contact the paper of the paper bag in the mouth flattening configuration, for example. In other examples, alternatively or in addition, the friction coating is provided on one or more of the other fingers of the finger assembly 602.

In some examples, the finger assembly 602 is configured to move, when in the mouth flattening configuration, along the third axis 810 to pull the paper bag 300 away from a conveyor and into the jaw grasping position. As described above in relation to the bag folding assembly 100, the jaw grasping position is a position at which the paper bag 300 is appropriately located for the first and second jaw assemblies 102, 104 to grasp the region 302 of the paper bag 300. For example, when the paper bag 300 is pulled off of the conveyor, it may be supported on the above-described platform (not shown in the Figures).

Therefore, in some examples, the finger assembly 602 moves while grasping the flat mouth portion so as to position the flat mouth portion at the jaw grasping position. Then, the flat mouth portion may be transferred to the bag folding assembly 100 in order for the bag folding assembly to perform its function according to any of the examples described above.

However, in some other examples, the finger assembly 602 remains positioned at or close to the jaw grasping position, and it is the paper bag 300 which moves towards the finger assembly 602. In some such examples, the finger assembly 602 may not grasp the mouth region 302 to the degree described above. For example, there may be no friction coating and the like on any of the fingers. In some examples, there is provided a pusher mechanism configured to push the paper bag towards the finger assembly 602.

For example, the pusher mechanism is configured to push the paper bag 300 from a top conveyor onto the packaging platform proximal to the finger assembly 602 as compared to the top conveyor. As previously described, the paper bag 300 moves correspondingly with the first and second jaw assemblies 102, 104 during transition from the upper jaw assembly position to the lower jaw assembly position while supported on a packaging platform.

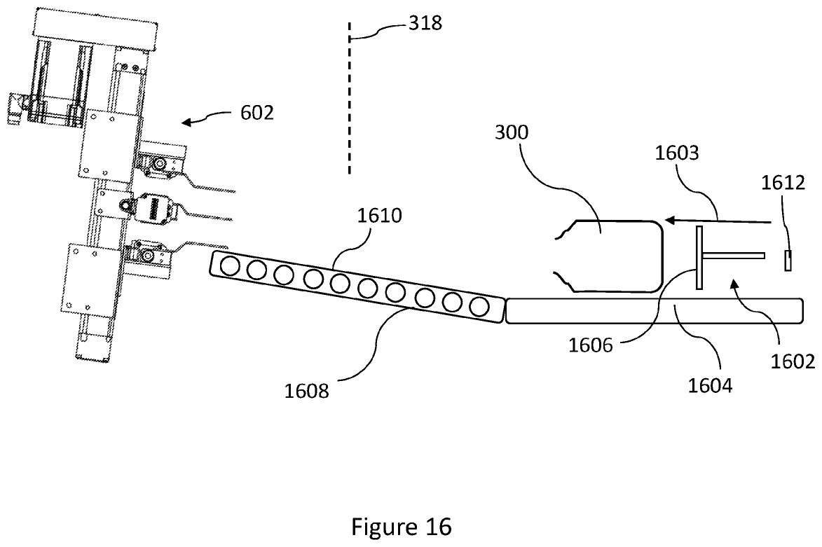

FIG. 16 is a schematic side view of examples comprising the pusher mechanism 1602. For example, the pusher mechanism 1602 is provided on the top conveyor 1604. In these examples, the pusher mechanism 1602 comprises a pushing plate 1606 configured to push the paper bag 300 onto the packaging platform 1608, for example in the direction indicated by arrow 1603. For example, the pusher mechanism 1602 may be configured such that the force, acceleration and like of the pushing plate 1606 can be well controlled.

In the examples of FIG. 16, there is provided a sensor 1612 configured to activate the pusher mechanism 1602 when the sensor 1612 senses that there is an item (such as the paper bag 300) positioned on the top conveyor 1604 in line with the sensor 1612. The sensor 1612 is, for example, an optical sensor. However, any suitable sensor may be used, for example a sensor which senses an increase in weight at a particular position and the like.

In these examples, the packaging platform 1608 comprises a driven belt 1610 for conveying the paper bag 300 towards the finger assembly 602. For example, the pushing plate 1606 pushes the paper bag off of the top conveyor 1604 and onto the packaging platform 1608, for the packaging platform to then convey the paper bag 300 further towards the finger assembly 602.

In some examples, the pusher mechanism 1602 is configured to accelerate to match an operation speed of the driven belt 1610 of the packaging platform 1608. For example, for a smooth transition, it may be desired that there are no sudden changes in speed as the paper bag 300 moves towards the finger assembly 602. For example, it may be desired that the transition is smooth such that the contents of the paper bag 300 are not unduly disturbed.

In some examples, the packaging platform 1608 is oriented such that the mouth region of the paper bag is positioned above an end of the paper bag opposite to the mouth region 302, when the paper bag 300 is disposed on the packaging platform 1608. In some examples, the packaging platform forms an angle of 10 degrees relative to the ground. For example, by providing such an orientation, it may reduce the chances of the contents tipping out.

In some examples, the paper bag 300 may contain contents which can tip in an undesired manner (e.g., slices of bread). Therefore, providing an angled packaging platform 1608 mitigates such tipping. As previously described, the packaging platform 1608 moves relative to the level change axis 318. For example, the packaging platform 1608 maintains its angle during the transition from the upper jaw assembly position to the lower jaw assembly position. Such an orientation corresponds for example to FIG. 13 described above.

In some examples, the length of the elongate members (which constitute the fingers of the finger assembly 602) are such that at least some of the elongate members (fingers) are in contact with the contents inside the paper bag, when the paper bag is in a jaw grasping position. For example, such contact may help to avoid the contents (for example, slices of bread) from tipping over. In some examples, the driven belt 1610 is configured to decelerate starting from a time immediately before the at least some of the fingers are in contact with the contents inside the paper bag 300. For example, the driven belt 1610 is controlled to decelerate just before the fingers contact the contents of the paper bag 300. In this manner, the deceleration of the driven belt 1610 may be coordinated with the position of the finger assembly 602 to avoid the contents from tipping over.

In some examples, the finger assembly 602 is configured to move from the mouth flattening configuration to a finger extraction configuration. For example, the finger extraction configuration is used to readily extract all the fingers from the flat mouth portion and/or to provide for the transfer of engagement of the flat mouth portion with the finger assembly 602 to another assembly (e.g., the bag folding assembly 100).

In some examples, the finger extraction configuration is a configuration in which tension in the material of the paper bag 300 is relieved compared to the mouth flattening configuration so that the fingers of the finger assembly 602 no longer grasp the flat mouth portion (in examples where such grasping occurs). Referring to FIGS. 8c and 9c, to transition to the finger extraction configuration from the particular mouth flattening configuration shown in these Figures, the outer fingers 710a, 710b may move slightly apart with respect to the first axis 704. In some examples where the fingers do not grasp the mouth region 302 so as to pull it off the top conveyor, this movement of the outer fingers 710a, 710b may be enough to achieve the desired finger extraction configuration.

In other examples, in addition to the outer fingers 710a, 710b moving slightly apart with respect to the first axis 704, the first and second inner fingers 702a, 702b may move closer to one another with respect to the first axis 704. In addition, the third and fourth inner fingers 706a, 706b may move closer to one another with respect to the first axis 704. For example, the movements are slight in the sense that the flat mouth portion is not significantly disturbed when the tension/grasp is released to an appropriate degree such that the fingers can be readily extracted. For example, in the finger extraction configuration, it is no longer the case that relative sliding with respect to the third axis 810 of the fingers and the flat mouth portion Is at least inhibited.

In some examples, the first and second jaw assemblies 102, 104 are configured to grasp the flat mouth portion when the flat mouth portion is engaged with the finger assembly. The first and second jaw assemblies 102, 104 may be configured to grasp the flat mouth portion before, during or after movement from the mouth flattening configuration to the finger extraction configuration.

In some examples, once the flat mouth portion has been pulled or pushed, as the case may be, into the jaw grasping position, the first and second jaw assemblies 102, 104 grasp the flat mouth portion. Then, the finger assembly 602 transitions from the mouth flattening configuration to the finger extraction configuration. Then, the fingers 702a, 702b, 706a, 706b, 710a, 710b disengage from the flat mouth portion, for example, by the finger assembly 602 moving along the third axis 810 away from the paper bag.

In some other examples, once the flat mouth portion has been pulled into the jaw grasping position, the finger assembly 602 transitions from the mouth flattening configuration to the finger extraction configuration, and the first and second jaw assemblies 102, 104 grasp the flat mouth portion during the time that this transition is occurring. Then, the fingers 702a, 702b, 706a, 706b, 710a, 710b disengage from the flat mouth portion, for example, by the finger assembly 602 moving along the third axis 810 away from the paper bag.

In some other examples, once the flat mouth portion has been pulled into the jaw grasping position, the finger assembly 602 transitions from the mouth flattening configuration to the finger extraction configuration. Then, after this transition, the first and second jaw assemblies 102, 104 grasp the flat mouth portion. Then, the fingers 702a, 702b, 706a, 706b, 710a, 710b disengage from the flat mouth portion, for example, by the finger assembly 602 moving along the third axis 810 away from the paper bag.

The above are examples of ways in which the mouth region 302, once prepared into the flat mouth portion, may be transitioned from engagement with the finger assembly 602 to engagement with the bag folding assembly 100. In the examples of FIG. 6a, the paper bag has been pulled into the jaw grasping position and the first and second jaw assemblies 102, 104 are in the upper jaw assembly position. However, in the examples of FIG. 6a, the first and second jaw assemblies are not at the above-described operational separation. FIG. 6b is a schematic perspective view of the packaging apparatus 600 and the paper bag 300, according to examples, at a more advanced stage to FIG. 6a. In the examples of FIG. 6b, the first and second jaw assemblies 102, 104 are at the operational separation. FIG. 6c is a schematic perspective view of the packaging apparatus 600 and the paper bag 300, according to examples, is at a more advanced stage to FIG. 6b. In the examples of FIG. 6c, the fingers have been extracted from the flat mouth portion and the first and second jaw assemblies 102, 104 have grasped the flat mouth portion.

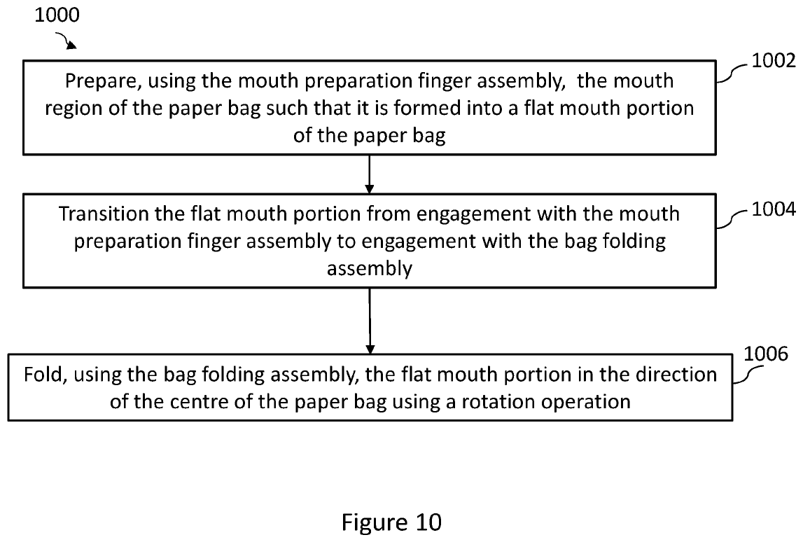

The above description of various assemblies and the packaging apparatus illustrates how a process to close a paper bag may be deployed. FIG. 10 is a flow diagram of a method 1000 for closing a paper bag. The method 1000 may utilise any of the examples of the assemblies and the packaging apparatus described above.

At block 1002 of the method 1000, the mouth region of the paper bag is prepared such that it is formed into a flat mouth portion of the paper bag, using the finger assembly 602. The flat mouth portion is prepared according to any of the above-described examples.

At block 1004 of the method 1000, the flat mouth portion is transitioned from engagement with the finger assembly 602 to engagement with the bag folding assembly 100. Such a transition may take place according to any of the described examples (for example, see FIGS. 6a to 6c).

At block 1006 of the method 1000, the flat mouth portion is folded, using the bag folding assembly 100, in the direction of the centre of the paper bag using a rotation operation. For example, the flat mouth portion is folded according to any of the above-described examples.

In some examples, the mouth portion 302 is formed into the flat mouth portion by the finger assembly 602 when the paper bag is positioned on a top conveyor. For example, a series of filled paper bags may be transported on the top conveyor (e.g., a conveyor belt as typically used in manufacturing or packaging facilities). For example, the filled paper bags may be placed on the top conveyor for transport towards the packaging apparatus, or the top conveyor may be involved in transporting the paper bags to one or more apparatuses preceding the packaging apparatus herein described. The filled paper bags may lie horizontally on the top conveyor (for example, such that the orientation shown in the Figures is deployed). The following description is in the context of the paper bag 300 illustrated in the Figures, according to examples.

The method 1000 may further comprise pulling, using the finger assembly 602, the paper bag 300 off of the top conveyor and into a bag folding assembly grasping position. For example, the bag folding assembly grasping position is the above-described jaw grasping position. For examples, the finger assembly 602 pulls the paper bag 300 into the jaw grasping position where the first and second jaw assemblies 102, 104 of the bag folding assembly 100 may grasp the mouth region 302. For example, the paper bag 300 may be supported on a packaging platform, as described above.

In these examples, the method 1000 comprises grasping, using the bag folding assembly 100, the flat mouth portion when the paper bag is in the jaw grasping position and before the finger assembly 602 disengages from the flat mouth portion. Accordingly, the method 1000 may provide for a transition from the finger assembly 602 to the bag folding assembly, in the manner as described above, for example.

Alternatively, in some examples of the method 1000, a pusher mechanism pushes the paper bag from a top conveyor onto an upwardly angled packaging platform; and the mouth portion 302 is then formed into the flat mouth portion by the mouth preparation finger assembly.

In some examples, the method 100 comprises moving the paper bag 300 in a lowering direction into a paper bag sealing position. For example, the lowering direction points below the top conveyor. For example, the lowering direction is along the above-described second axis 708. For example, the paper bag 300 may be moved in the lowering direction during the rotation operation when the first and second jaw assemblies 102, 104 move with respect to the level change axis 318, as described above, for example.

In some examples, the method 1000 further comprises performing, using a paper bag sealing assembly, a paper bag sealing operation to secure the folded mouth portion of the paper bag 300 and provide the paper bag 300 as a closed paper bag. For example, the paper bag may be closed using the label 316. In some such examples, the method 1000 further comprises depositing the closed paper bag onto a bottom conveyor positioned lower than the top conveyor with respect to the second axis 708.

For example, the paper bag sealing assembly is an assembly which applies a label, applies tape, applies one or more staples or the like, in order to seal the folded mouth portion. In some examples, the folded mouth portion is sealed against the remaining of the paper bag 300 (as is the case in the examples for FIGS. 3e, 3f, 4e and 4f, for instance). In some examples, the folded mouth portion is in the form of a tab as described above and is simply sealed in the sense that the folded mouth portion is secured such that it does not unfold.

In some examples, the paper bag sealing assembly performs the paper bag sealing operation before the bag folding assembly 100 disengages from the folded mouth portion. For example, the paper bag sealing operation may be performed either before or after the first and second jaw assemblies 102, 104 adopt the fold release configuration. In either case, in these particular examples, the bag sealing operation may be performed before the first and second jaw assemblies 102, 104 move away from one another to disengage from the folded mouth portion.

In this manner, the paper bag 300 may be closed up in a reliable manner with neat folds which are tightly formed, for example. This may be particularly advantageous where the paper bag 300 is used to package food items. For example, bread may be packaged in the paper bag 300. In such examples, neatly formed tight folds are advantageous for avoiding significant air exposure to the bread so that the bread remains fresh as compared to bread that has a greater amount of air exposure. It will be appreciated that neatly formed tight folds may be advantages for various reasons and for various types of content the paper bag 300 is intended to be filled with.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing example(s). The invention extends to any novel one, or any novel combination, of the features disclosed in this specification (including any accompanying claims, abstract and drawings), or to any novel one, or any novel combination, of the steps of any method or process so disclosed.

1. A bag folding assembly for a packaging apparatus for preparing a paper bag to be closed, the bag folding assembly comprising:
a first jaw assembly and a second jaw assembly centred on a common operational axis, wherein:
each jaw assembly is configured to transition between an open configuration and a closed configuration wherein: in the open configuration the respective jaws are spread to be spaced apart from a region of a paper bag, and in the closed configuration the respective jaws are configured to grasp the region of the paper bag such that sliding of the region of the paper bag relative to the respective jaw assembly is inhibited;
the first jaw assembly and second jaw assembly are arranged with the jaws facing one another such that they are operable to grasp the region of the paper bag towards opposite edges of the region of the paper bag;
the first jaw assembly and second jaw assembly are configured to perform a rotation operation by simultaneously rotating about the operational axis to fold the paper bag by turning the region of the paper bag with respect to the operational axis;
each jaw of the first and second jaw assembly comprises a first lateral end and a second lateral end, the first lateral end and the second lateral end being separated by a width of said jaw, wherein the width of said jaw is perpendicular to the thickness of the jaw and perpendicular to the operational axis;
the operational axis is positioned between the first lateral end and the second lateral end of each jaw, such that the operational axis is positioned closer to one of the first and second lateral ends as compared to the other of the first and second lateral ends; and
in use, a separation between a longitudinal axis of the paper bag and the operational axis along a first direction remains substantially constant during the rotation operation, wherein the first direction is perpendicular to the longitudinal axis of the paper bag and perpendicular to the operational axis.

2. The bag folding assembly according to claim 1, wherein:
each jaw assembly is configured to grasp the region of the paper bag such that sliding of the region of the paper bag relative to the respective jaw assembly is prevented during the rotation operation.

3. The bag folding assembly according to claim 1, wherein:
the jaw assemblies are configured to move away from one another during the rotation operation.

4. The bag folding assembly according to claim 3, wherein:
the jaw assemblies are configured to move away from one another in a continuous manner during the rotation operation; or
the jaw assemblies are configured to move away from one another in a step-wise manner during the rotation operation.

5. The bag folding assembly according to claim 1, wherein:
each of the jaw assemblies comprises a gripping arrangement configured to generate friction between the jaws of the respective jaw assembly and the region of the paper bag when the region of the paper bag is grasped by the respective jaw assembly.

6. The bag folding assembly according to claim 5, wherein:
the gripping arrangement comprises a high friction member provided on each jaw, the high friction member configured to contact the region of the paper bag when the respective jaw assembly grasps the region of the paper bag.

7. The bag folding assembly according to claim 1, wherein:
each of the first and second jaw assemblies is configured to:
adopt a fold release configuration in which the respective jaws are marginally more open as compared to the closed configuration such that, when the region of the paper bag is positioned between the respective jaws, the region of the paper bag is able to readily slide relative to the respective jaw assembly.

8. The bag folding assembly according to claim 7, wherein:
the first and second jaw assemblies are configured to adopt the fold release configuration after performing the rotation operation, and move apart from one another after adopting the fold release configuration.

9. The bag folding assembly according to claim 1, wherein:
the operational axis is positioned closer to the first lateral end of each jaw; and
a first space created between the first lateral end of each jaw and the region of the paper bag during the rotation operation is greater than a second space created between the second lateral end of each jaw and the region of the paper bag during the rotation operation.

10. The bag folding assembly according to claim 9, wherein:
the first and second jaw assemblies are configured to move apart from one another after performing the rotation operation, while still in the closed configuration.

11. The bag folding assembly according to claim 1, wherein:
the first and second jaw assemblies are configured to move with respect to a level change axis simultaneously, wherein the level change axis is perpendicular to the operational axes.

12. The bag folding assembly according to claim 11, wherein:
the first and second jaw assemblies are configured to move with respect to the level change axis during the rotation operation.

13. The bag folding assembly according to claim 1, wherein:
the first and second jaw assemblies are configured to simultaneously perform the rotation operation when each jaw assembly is in the closed configuration.

14. The bag folding assembly according to claim 1, wherein:
each jaw is detachably connected to its respective jaw assembly.

15. The bag folding assembly according to claim 14, wherein:
each jaw assembly comprises a jaw detachable connection mechanism configured to allow a user to manually detach and re-attach jaws onto the respective jaw assembly.

16. The bag folding assembly according to claim 1, wherein:
the rotation operation comprises any rotation comprising an integer number of turns, a fractional number of turns or a combination of an integer number of turns and a fractional number of turns.

17. The bag folding assembly according to claim 16, wherein:
the first and second jaw assemblies are configured such that the rotation of the rotation operation is controlled to a precision of one degree.

18. A bag folding system for a packaging apparatus for preparing a paper bag to be closed, the bag folding system comprising:
the bag folding assembly according to claim 14; and
a plurality of sets of jaws, wherein each set of jaws comprises jaws having a width different to the widths of the jaws of the other sets of jaws in the plurality of sets of jaws.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method for closing a paper bag, the method comprising:
preparing, using a mouth preparation finger assembly, a mouth region of the paper bag such that it is formed into a flat mouth portion of the paper bag;
transitioning the flat mouth portion from engagement with the mouth preparation finger assembly to engagement with a bag folding assembly,
the bag folding assembly comprising:
a first jaw assembly and a second jaw assembly centred on a common operational axis,
wherein:
each jaw assembly is configured to transition between an open configuration and a closed configuration wherein: in the open configuration the respective jaws are spread to be spaced apart from the flat mouth portion of the paper bag, and in the closed configuration the respective jaws are configured to grasp the flat mouth portion of the paper bag such that sliding of the flat mouth portion of the paper bag relative to the respective jaw assembly is inhibited;
the first jaw assembly and second jaw assembly are arranged with the jaws facing one another such that they are operable to grasp the flat mouth portion of the paper bag towards opposite edges of the flat mouth portion of the paper bag;
each jaw of the first and second jaw assembly comprises a first lateral end and a second lateral end, the first lateral end and the second lateral end being separated by a width of said jaw, wherein the width of said jaw is perpendicular to the thickness of the jaw and perpendicular to the operational axis;
the operational axis is positioned between the first lateral end and the second lateral end of each jaw, such that the operational axis is positioned closer to one of the first and second lateral ends as compared to the other of the first and second lateral ends; and
in use, a separation between a longitudinal axis of the paper bag and the operational axis along a first direction remains substantially constant during the rotation operation, wherein the first direction is perpendicular to the longitudinal axis of the paper bag and perpendicular to the operational axis; and
folding, using the bag folding assembly, the flat mouth portion in the direction of the centre of the paper bag using a rotation operation by simultaneously rotating the first jaw assembly and second jaw assembly about the operational axis to fold the paper bag by turning the flat mouth portion of the paper bag with respect to the operational axis.

37. The method according to claim 36, wherein:
the mouth portion is formed into the flat mouth portion by the mouth preparation finger assembly when the paper bag is positioned on a top conveyor,
the method comprising:
pulling, using the mouth preparation finger assembly, the paper bag off of the top conveyor and into a bag folding assembly grasping position;
grasping, using the bag folding assembly, the flat mouth portion while the paper bag is in the bag folding assembly grasping position and before the mouth preparation finger assembly disengages from the flat mouth portion.

38. (canceled)

39. (canceled)

40. (canceled)
